(19) United States
(12) Patent Application Publication
(10) Pub. No.: US 2024/0264330 A1
(43) Pub. Date: Aug. 8, 2024

(54) INFORMATION PROCESSING APPARATUS, SYSTEM, METHOD, AND STORAGE MEDIUM

(71) Applicant: KABUSHIKI KAISHA TOSHIBA, Tokyo (JP)

(72) Inventors: Daisuke UCHIDA, Kawasaki Kanagawa (JP); Tomoya TANDAI, Ota Tokyo (JP); Koji AKITA, Yokohama Kanagawa (JP)

(73) Assignee: KABUSHIKI KAISHA TOSHIBA, Tokyo (JP)

(21) Appl. No.: 18/455,623

(22) Filed: Aug. 25, 2023

(30) Foreign Application Priority Data
Feb. 7, 2023 (JP) 2023-016918

(51) Int. Cl. G01V 3/12

(52) U.S. Cl. CPC G01V 3/12

(57) ABSTRACT

According to one embodiment, an information processing apparatus includes a processor configured to acquire first reception power of a first signal radiated from an antenna when the first signal is received at a first point, acquire second reception power of a second signal radiated from the antenna, the second signal being different from the first signal, when the second signal is received at a second point, and determine, based on a difference between periodicity of the acquired first reception power and periodicity of the acquired second reception power, presence or absence of an object in a space facing the antenna with the second point interposed between the antenna and the space.

### CROSS-REFERENCE TO RELATED APPLICATIONS

This application is based upon and claims the benefit of priority from Japanese Patent Application No. 2023-016918, filed Feb. 7, 2023, the entire contents of which are incorporated herein by reference.

### FIELD

Embodiments described herein relate generally to an information processing apparatus, a system, a method, and a storage medium.

### BACKGROUND

In recent years, it is known to control a moving body (for example, a mobile robot or the like) moving in a predetermined space by, for example, executing wireless communication. In this case, for example, the moving body is controlled to move along a route from a start point to a goal point set on a map of a space where the moving body moves.

Meanwhile, a control signal for controlling the moving body is radiated from an antenna by a radio wave, but in a case where an object (hereinafter, described as an obstacle) is disposed in the space where the moving body moves, there is a possibility that a propagation environment of a signal in a space (that is, a space behind the obstacle when viewed from the antenna) facing the antenna with the obstacle interposed therebetween deteriorates (that is, a dead zone in which reception power decreases is generated) by the obstacle. In such a case, a route that avoids the dead zone can be selected.

Here, since the signal propagation environment in the dead zone is improved (recovered) when the above-described obstacle is removed, the moving body does not need to move while avoiding the space that has been the dead zone.

However, it is difficult to efficiently grasp the signal propagation environment in the space where the moving body moves (that is, the signal propagation environment in the dead zone has been improved).

### BRIEF DESCRIPTION OF THE DRAWINGS

FIG. 1 is a diagram illustrating an example of a local 5G system applied to an embodiment.

FIG. 2 is a diagram illustrating an example of a target space.

FIG. 3 is a diagram illustrating an example of an environment assumed in the present embodiment.

FIG. 4 is a diagram illustrating an obstacle disposed in the target space.

FIG. 5 is a diagram illustrating an example of a functional configuration of a moving body.

FIG. 6 is a diagram illustrating an example of a functional configuration of an information processing apparatus.

FIG. 7 is a diagram illustrating an example of a system configuration of the information processing apparatus.

FIG. 8 is a flowchart illustrating an example of a processing procedure of the information processing apparatus.

FIG. 9 is a diagram illustrating reception power used to detect an obstacle.

FIG. 10 is a diagram illustrating the reception power used to detect the obstacle.

FIG. 11 is a diagram illustrating the reception power used to detect the obstacle.

FIG. 12 is a diagram illustrating the reception power used to detect the obstacle.

FIG. 13 is a diagram illustrating the reception power used to detect the obstacle.

FIG. 14 is a diagram illustrating the reception power used to detect the obstacle.

FIG. 15 is a diagram illustrating the reception power used to detect the obstacle.

FIG. 16 is a diagram illustrating the reception power used to detect the obstacle.

FIG. 17 is a diagram illustrating the reception power used to detect the obstacle.

FIG. 18 is a diagram illustrating the reception power used to detect the obstacle.

FIG. 19 is a diagram illustrating a route along which a signal transmitted from a transmission point reaches a reception point.

FIG. 20 is a diagram illustrating an example of a delay profile.

FIG. 21 is an enlarged view of a part of the delay profile.

FIG. 22 is a diagram illustrating a reference signal used to measure reception power.

FIG. 23 is a diagram illustrating an example of a reception power map in which spatial reception power is represented in grayscale.

FIG. 24 is a diagram illustrating an example of spectrum display in which a horizontal axis represents a component of a spatial frequency and a vertical axis represents a component amount of the component of the spatial frequency.

FIG. 25 is a diagram illustrating an example of spectrum display in which a horizontal axis represents a component of a spatial wavelength and a vertical axis represents a component amount of the component of the spatial wavelength.

FIG. 26 is a diagram illustrating an example of a spectrum of the spatial frequency.

FIG. 27 is an enlarged view of a part of a spatial frequency spectrum.

FIG. 28 is a diagram illustrating an example of a target space in which a plurality of obstacles are disposed.

### DETAILED DESCRIPTION

In general, according to one embodiment, an information processing apparatus includes a processor configured to acquire first reception power of a first signal radiated from an antenna when the first signal is received at a first point, acquire second reception power of a second signal radiated from the antenna, the second signal being different from the first signal, when the second signal is received at a second point, and determine, based on a difference between periodicity of the acquired first reception power and periodicity of the acquired second reception power, presence or absence of an object in a space facing the antenna with the second point interposed between the antenna and the space.

Various embodiments will be described with reference to the accompanying drawings.

An information processing apparatus according to the present embodiment is used to control a moving body (a mobile robot) that moves in a predetermined space (hereinafter, referred to as a target space) such as a factory.

Hereinafter, a scenario to which the information processing apparatus according to the present embodiment is applied will be described. In a case where a moving body moves on a straight line along a passage in a target space, control on the moving body may be simple, but for example, in a case where the passage arranged in the target space is curved or avoids an object (hereinafter, described as an obstacle) disposed in the target space, more advanced control is required.

Meanwhile, in a case where such control of the moving body is performed by wire (that is, a control signal for controlling the moving body is transmitted by wire), there are problems that a range in which the moving body can move is limited, the control of the moving body becomes impossible due to disconnection, and wiring work is complicated. Particularly, in a case where a large number of moving bodies move in the target space, these problems become remarkable.

On the other hand, in a case where the control of the moving body is wirelessly performed (that is, wireless control of the moving body is performed), the above-described problem can be solved. For example, local 5G can be used for wireless control of such a moving body. The local 5G is, for example, a 5G network that can be individually used by a company or the like, and is useful in an environment in which a large number of moving bodies moving in a target space are wirelessly controlled because it is possible to realize high speed, low delay, and multiple simultaneous connections. It is noted that a wireless LAN can also be used for wireless control of the moving body.

Here, the above-described moving body can be roughly divided into one moving body that operates autonomously and the other moving body that operates based on a command from the outside (a control signal). The moving body that autonomously operates is useful because each of the moving bodies can operate by determining the situation, but the cost is high, and it is difficult to apply the moving body to a case in which a large number of moving bodies are disposed in the target space. On the other hand, in the case of the other moving body that operates based on the command from the outside as described above, it is possible to reduce the total cost of a system including the moving body and the information processing apparatus by integrating the functions of controlling a large number of moving bodies into one apparatus (for example, the information processing apparatus). In addition, since it is possible to collectively manage information of a large number of moving bodies moving in the target space, it is relatively easy to manage the moving bodies. It is noted that capability of collectively grasping information on a large number of moving bodies is also advantageous from a viewpoint of optimizing the movement of the entire moving body.

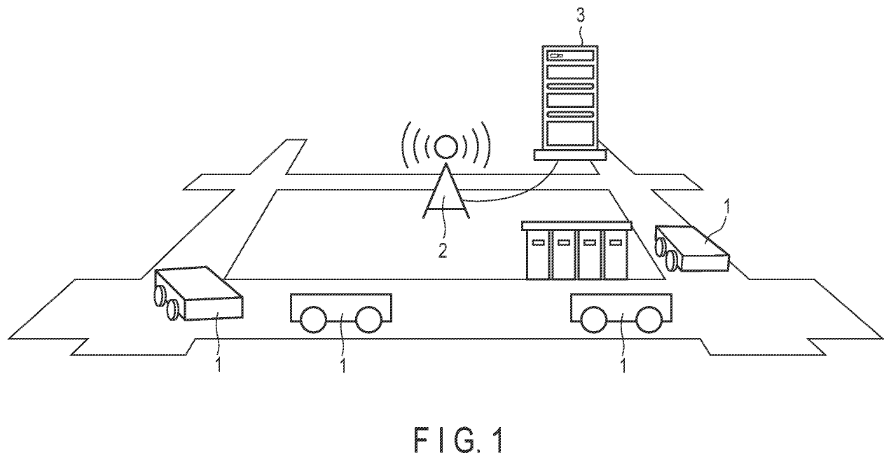

Hereinafter, as illustrated in FIG. 1, it is assumed that a local 5G system (cellular system) that performs terminal-side control on the base station side is applied to the present embodiment.

In the example illustrated in FIG. 1, a situation in which a plurality of moving bodies 1 move in a target space is assumed. Each of the plurality of moving bodies 1 has a radio device mounted thereon and is communicably connected to a base station 2. Furthermore, an information processing apparatus 3 is connected to the base station 2, and a control signal for controlling the moving body 1, the control signal being generated by the information processing apparatus 3, is transmitted from (an antenna installed in) the base station 2 to the moving body 1. That is, it can be said that the moving body 1 is communicably connected to the information processing apparatus 3 via the base station 2. As a result, the moving body 1 can move in the target space based on the control signal generated in the information processing apparatus 3.

It is noted that FIG. 1 assumes a case in which the moving body 1 is, for example, an autonomous mobile robot (AMR), and the information processing apparatus 3 is, for example, a server apparatus referred to as mobile edge computing (MEC). The information processing apparatus 3 may be a server apparatus that provides a cloud computing service.

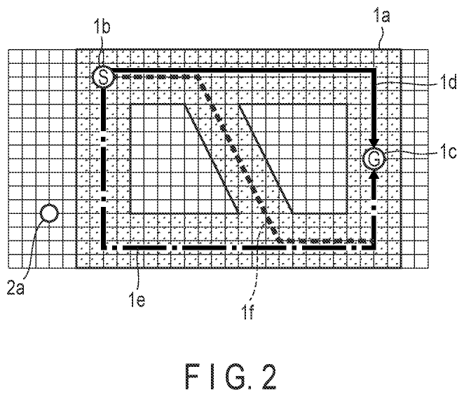

Here, it is assumed that the moving body 1 is controlled to be movable in the target space illustrated in FIG. 2. Here, a situation in which the moving body 1 moves from a start point 1b to a goal point 1c along a passage (for example, a traveling path provided in a factory or a warehouse) la in the target space in order to carry (convey) a load such as a cardboard box is considered.

In this case, as a route configured to allow the moving body 1 to move from the start point 1b to the goal point 1c, there are a route 1d corresponding to the shortest route, a route 1e corresponding to the longest route, and a route 1f corresponding to an intermediate route with respect to the shortest route and the longest route.

According to the target space illustrated in FIG. 2 described above, the route 1d (that is, the shortest route) is selected from among the routes 1d to 1f, thereby making it possible to control the moving body 1 so as to efficiently move from the start point 1b to the goal point 1c. The control signal for controlling the moving body 1 in this manner is radiated from, for example, an antenna 2a installed in the base station 2 to the moving body 1. The antenna 2a is disposed, for example, in the target space. It is noted that, here, it has been described that the moving body 1 moves from the start point 1b to the goal point 1c in order to carry a load, but such a load is not carried only once. For example, the moving body 1 returns to the start point 1b again after carrying the previous load from the start point 1b to the goal point 1c, and repeatedly performs an operation of carrying another load from the start point 1b to the goal point 1c.

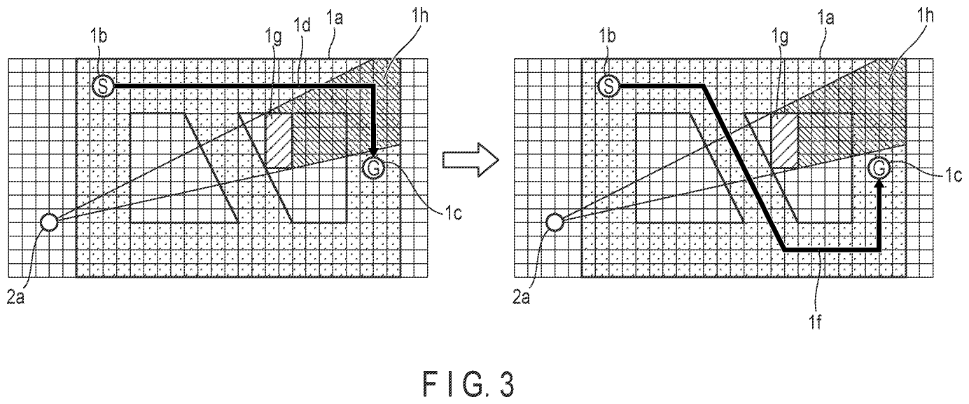

Here, in a case where the target space in which the moving body 1 moves is, for example, a factory or the like, it is assumed that the arrangement of obstacles (such as cardboard boxes carried by the moving body 1) in the target space changes according to the lapse of time. Here, as described above, for example, in a situation in which the moving body 1 repeatedly carries a load from the start point 1b to the goal point 1c illustrated in FIG. 2 (that is, the plurality of moving bodies 1 sequentially move along a determined route), it is assumed that an obstacle 1g is disposed in the target space as illustrated on the left side of FIG. 3.

When a signal (for example, the control signal or the like) is radiated from the antenna 2a by a radio wave and the obstacle 1g is a radio wave shielding object that shields a radio wave, such as metal (that is, for example, the obstacle is a cardboard box or the like in which a radio wave shielding object is packed), the signal radiated from the antenna 2a is shielded by the obstacle 1g, so that a propagation environment of the signal in a space 1h facing the antenna 2a with the obstacle 1g interposed between the antenna 2a and the space 1h deteriorates (that is, a dead zone 1h in which reception power decreases is generated).

In the example illustrated in FIG. 3, the space (that is, the dead zone) 1h in which the propagation environment of the signal deteriorates overlaps the route 1d. Accordingly, when the moving body 1 moves along the route 1d, there is a possibility that the moving body 1 cannot normally receive the control signal in the dead zone 1h. That is, the obstacle 1g disposed in the target space as described above becomes a factor that hinders efficient movement (control) of the moving body 1.

In a case where the dead zone 1h is generated in this manner, for example, by changing the route 1d to the route 1f (intermediate route) as illustrated on the right side of FIG. 3, the moving body 1 can be controlled to avoid the dead zone 1h.

Meanwhile, in a situation where the plurality of moving bodies 1 repeatedly carry loads along the route 1f changed from the route 1d (that is, the plurality of moving bodies 1 repeatedly move between the start point 1b and the goal point 1c), when the obstacle 1g disposed in the target space is removed according to the lapse of time, (deterioration in) the propagation environment of the signal in the dead zone 1h is improved, and the dead zone 1h is eliminated. In this case, it is preferable to grasp the elimination of the dead zone 1h and to change the route on which the moving body 1 moves from the route 1f to the route 1d again (that is, the route 1d is selected again as an appropriate route of the moving body 1).

Here, a description will be given as to a method of grasping the elimination of the dead zone 1h in a comparative example of the present embodiment.

First, the moving body 1 is controlled to move along the route 1d at any timing when the moving body 1 repeatedly carries a load along the route 1f, and a synchronization signal is radiated from the antenna 2a (the base station 2) when the moving body 1 passes through the dead zone 1h. The moving body 1 measures reception power of the synchronization signal by receiving the synchronization signal radiated from the antenna 2a.

In the comparative example of the present embodiment, as described above, when the reception power measured in the dead zone 1h is equal to or greater than a threshold value, it is possible to grasp that the dead zone 1h is eliminated (that is, the signal propagation environment in the dead zone 1h has improved). On the other hand, if the reception power measured in the dead zone 1h is less than the threshold value, it can be grasped that the dead zone 1h is not eliminated.

However, in a case where the moving body 1 is moved to the dead zone 1h in a state where the dead zone 1h is not eliminated (that is, the obstacle 1g has not been removed), there is a possibility that the moving body 1 cannot appropriately receive the control signal in the dead zone 1h and does not normally operate (for example, the operation stops). In this case, it takes time to restart the normal operation of the moving body 1, and it cannot be said that the elimination of the dead zone 1h can be efficiently grasped. Furthermore, movement of the moving body 1 in the dead zone 1h may cause an accident or the like due to the inability to appropriately receive a control signal (that is, an instruction to change the moving speed of the moving body 1 and the moving direction thereof, and the like).

Furthermore, for example, it is conceivable to directly detect the presence or absence of the obstacle 1g without moving the moving body 1 to the dead zone 1h described above by using the reflection of a laser emitted from the moving body 1.

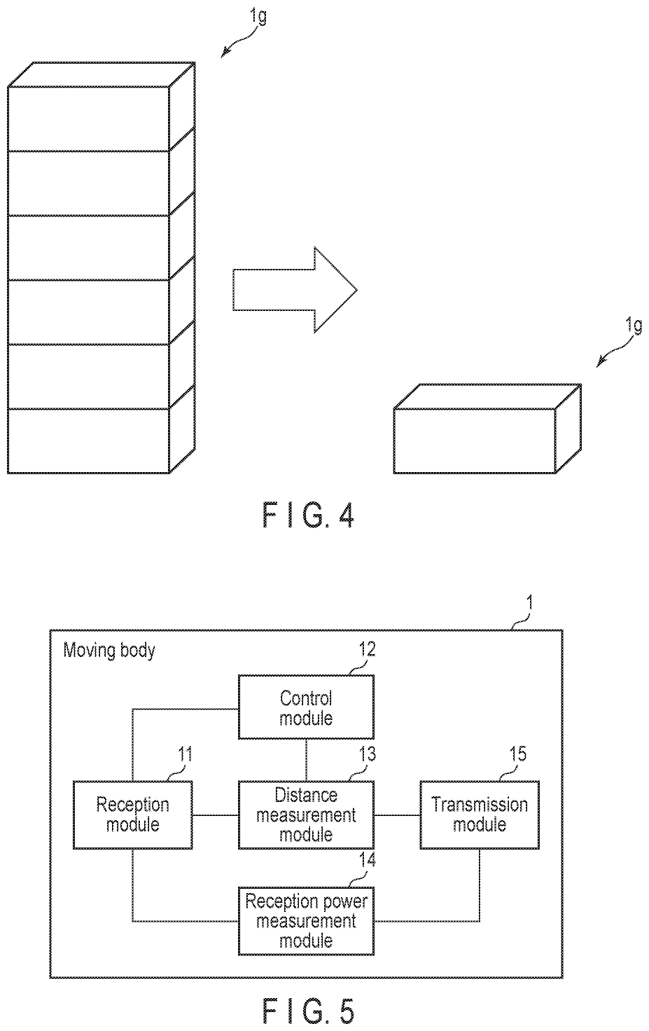

However, as described above, in a situation where the moving body 1 moves in the target space such as the factory, for example, there is a case in which the obstacle 1g having a plurality of cardboard boxes for packing radio wave shielding objects stacked in the height direction (that is, the cardboard boxes are vertically loaded) is disposed, and the height of the obstacle 1g changes when the cardboard boxes are removed or further stacked. The propagation environment of the signal is considered to depend on the height of such an obstacle 1g. Specifically, for example, in the case of the obstacle 1g having a large number of cardboard boxes stacked in the height direction as illustrated on the left side of FIG. 4, the dead zone 1h is generated by the obstacle 1g, whereas in the case where the number of cardboard boxes of the obstacle 1g is reduced as illustrated on the right side of FIG. 4, there is a possibility that the influence of the obstacle 1g is reduced and the dead zone 1h is eliminated.

On the other hand, according to the straightness of the laser emitted from the moving body 1 as described above, it is difficult to grasp the height direction of the obstacle 1g, and as such it is not possible to grasp the elimination of the dead zone 1h in consideration of the height direction of the obstacle 1g. Although it is conceivable to apply a mechanism capable of grasping the height direction to the moving body 1, in a case where a plurality of moving bodies 1 are controlled, the cost of constructing a system increases.

Furthermore, in a case where the obstacle 1g, which is the radio wave shielding object, is replaced with an obstacle, which is not the radio wave shielding object, the dead zone 1h may be eliminated even if the obstacle is disposed.

That is, even if the presence or absence of the obstacle is detected by using the reflection of the laser emitted from the moving body 1, it may not be possible to appropriately grasp the elimination of the dead zone 1h based on the detection result thereof.

Therefore, in the present embodiment, a description will be given as to a moving body control system capable of estimating (analogizing) a propagation environment of a signal in a target zone (space) such as a dead zone while avoiding a situation in which the moving body 1 cannot normally operate. As illustrated in FIG. 1, the moving body control system according to the present embodiment includes the moving body 1 (for example, the AMR) and the information processing apparatus 3 (for example, the MEC) communicably connected to the moving body 1 via the base station 2.

First, an example of a functional configuration of the moving body 1 will be described with reference to FIG. 5. As illustrated in FIG. 5, the moving body 1 includes a reception module 11, a control module 12, a distance measurement module 13, a reception power measurement module 14, and a transmission module 15.

The reception module 11 receives a control signal for controlling the moving body 1. The control signal received by the reception module 11 is output to the control module 12. Furthermore, the reception module 11 receives a synchronization signal for measuring reception power to be described later. The synchronization signal received by the reception module 11 is output to the reception power measurement module 14. It is noted that the control signal and the synchronization signal are radiated from an antenna installed in the base station 2 to the moving body 1.

The control module 12 controls the moving body 1 based on the control signal output from the reception module 11. The moving body 1 includes wheels or the like for moving the moving body 1, and the control module 12 moves the moving body 1 by controlling a rotation speed and a direction (that is, a moving speed and a direction of the moving body 1) of the wheels according to the control signal. The moving speed and the direction of the moving body 1 controlled by the control module 12 are output to the distance measurement module 13.

The distance measurement module 13 is implemented by, for example, an optical distance sensor (a laser range finder (LRF)) or the like, and measures a distance from the moving body 1 to a wall or an obstacle existing around the moving body 1 based on a time (time of flight (TOF)) until laser (light) emitted from the LRF is reflected. The distance (LRF scan data indicating the distance) measured by the distance measurement module 13 and the moving speed and the direction of the moving body 1 (data indicating the moving speed and the direction) output from the control module 12 in this manner are output to the transmission module 15 as data for generating map data to be described later (hereinafter, referred to as map generation data).

The reception power measurement module 14 measures the reception power (radio field intensity) of the synchronization signal based on the synchronization signal output from the reception module 11. Reception power data indicating the reception power measured by the reception power measurement module 14 is transmitted to the transmission module 15.

The transmission module 15 transmits the map generation data output from the distance measurement module 13 to the information processing apparatus 3. In addition, the transmission module 15 transmits the reception power data output from the reception power measurement module 14 to the information processing apparatus 3.

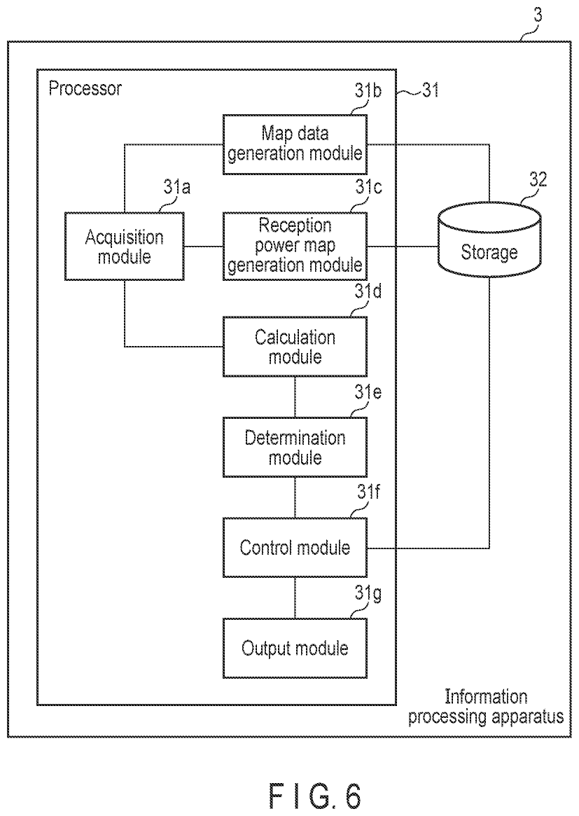

Next, an example of a functional configuration of the information processing apparatus 3 will be described with reference to FIG. 6. It is noted that the information processing apparatus 3 according to the present embodiment is configured to acquire data from the moving body 1 side via the base station 2 described above and to instruct the moving body 1 on a route (a travelling route) on which the moving body 1 moves.

It is noted that, although it is assumed in the present embodiment that the information processing apparatus 3 is the MEC, the information processing apparatus 3 may be implemented as a server apparatus or the like disposed far from the base station 2 via a network, or may be implemented as a local controller or the like directly connected to the base station 2.

As illustrated in FIG. 6, the information processing apparatus 3 includes a processor 31 and a storage 32. In addition, the processor 31 includes an acquisition module 31a, a map data generation module 31b, a reception power map generation module 31c, a calculation module 31d, a determination module 31e, a control module 31f, and an output module 31g.

The map generation data and the reception power data transmitted by the transmission module 15 included in the moving body 1 described above are received by (the antenna installed in) the base station 2. The acquisition module 31a acquires, from the base station 2, the map generation data and the reception power data received by the base station 2. The map generation data acquired by the acquisition module 31a is output to the map data generation module 31b, the reception power map generation module 31c, and the calculation module 31d. The reception power data acquired by the acquisition module 31a is output to the reception power map generation module 31c and the calculation module 31d.

The map data generation module 31b generates map data indicating a map of a target space based on the map generation data output from the acquisition module 31a. The map data generated by the map data generation module 31b is stored in the storage 32.

The reception power map generation module 31c generates a reception power map of the target space based on the map generation data and the reception power data output from the acquisition module 31a. The reception power map generated by the reception power map generation module 31c is stored in the storage 32.

The calculation module 31d calculates the periodicity of the reception power measured in the moving body 1 moving in the target space, for example, based on the map generation data and the reception power data output from the acquisition module 31a. It is noted that details of the periodicity of the reception power calculated by the calculation module 31d will be described later. The periodicity of the reception power calculated by the calculation module 31d is output to the determination module 31e.

The determination module 31e determines the presence or absence of an obstacle in a space in the vicinity of a point (a position of the moving body 1 when the synchronization signal is received) where the reception power is measured in the moving body 1 (the reception power measurement module 14) based on the periodicity of the reception power output from the calculation module 31d. Specifically, the determination module 31e determines the presence or absence of an obstacle in a space facing the antenna installed in the base station 2 across the point where the reception power is measured based on, for example, a difference between the periodicity of past reception power and the periodicity of current reception power.

That is, it can be said that the information processing apparatus 3 according to the present embodiment has a function of detecting an obstacle (for example, a radio wave shielding object) based on the periodicity of the reception power with respect to the target space measured by the moving body 1 (the radio device) moving in the target space.

The control module 31f generates a control signal for controlling the moving body 1 based on the map data and the reception power map stored in the storage 32 and the determination result (presence or absence of an obstacle) by the determination module 31e. The control signal generated by the control module 31f is output to the output module 31g.

The output module 31g outputs the control signal output from the control module 31f to the base station 2. The control signal output from the output module 31g in this manner is radiated from the antenna installed in the base station 2 to the moving body 1.

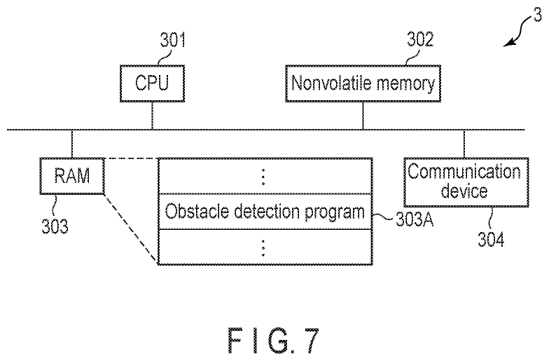

FIG. 7 illustrates an example of a system configuration of the information processing apparatus 3 illustrated in FIG. 6. The information processing apparatus 3 includes a CPU 301, a nonvolatile memory 302, an RAM 303, a communication device 304, and the like.

The CPU 301 is a processor for controlling operations of various components in the information processing apparatus 3. The CPU 301 may be a single processor or may include a plurality of processors. The CPU 301 executes various programs loaded from the nonvolatile memory 302 to the RAM 303. These programs include various application programs such as an operating system (OS) and an obstacle detection program 303A for detecting an obstacle as described above.

The nonvolatile memory 302 is a storage medium used as an auxiliary storage device. The RAM 303 is a storage medium used as a main storage device. Although only the nonvolatile memory 302 and the RAM 303 are illustrated in FIG. 7, the information processing apparatus 3 may include other storage devices such as a hard disk drive (HDD) and a solid state drive (SSD).

The communication device 304 is a device configured to perform wired communication or wireless communication. Although it is assumed that the information processing apparatus 3 according to the present embodiment is connected to the base station 2 by wire (cable), the information processing apparatus 3 may be connected to the base station 2 so as to execute wireless communication via a network.

In the present embodiment, the processor 31 illustrated in FIG. 6 is implemented by at least one processor. The processor includes, for example, a control device and an arithmetic device, and is implemented by an analog or digital circuit or the like. The processor may be the CPU 301 described above, or may be a general-purpose processor, a microprocessor, a digital signal processor (DSP), an ASIC, an FPGA, or a combination thereof.

In addition, a part or all of the processor 31 can be implemented by causing the CPU 301 (that is, the computer of the information processing apparatus 3) to execute the obstacle detection program 303A, that is, by software. The obstacle detection program 303A may be stored in a computer-readable storage medium and distributed, or may be downloaded to the information processing apparatus 3 via a network. It is noted that a part or all of the processor 31 may be implemented by dedicated hardware or the like, or may be implemented by a combination of software and hardware.

In the present embodiment, the storage 32 illustrated in FIG. 6 is implemented by, for example, the nonvolatile memory 302 or another storage device.

It is noted that, although detailed description is omitted, a part or all of the modules 11 to 15 included in the moving body 1 illustrated in FIG. 5 may be implemented by allowing a CPU included in the moving body 1 to execute a predetermined program (that is, software), may be implemented by hardware, or may be implemented by a combination of software and hardware.

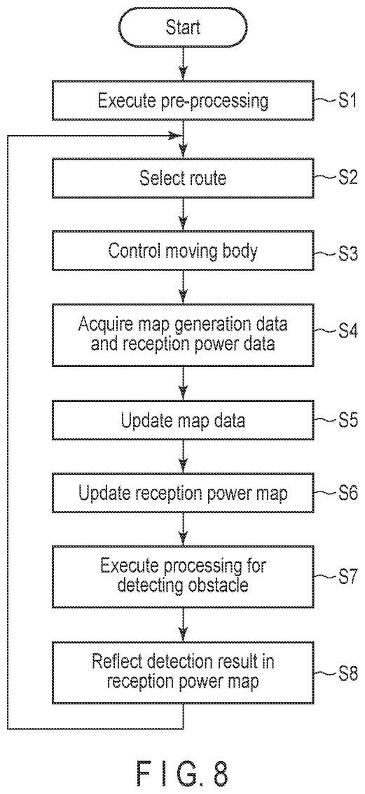

Hereinafter, an example of a processing procedure of the information processing apparatus 3 according to the present embodiment will be described with reference to a flowchart in FIG. 8.

In the information processing apparatus 3 according to the present embodiment, processing of generating map data and a reception power map is executed as pre-processing (preparation) before starting operation of the moving body control system (step S1).

First, the processing of generating the map data will be described. In a case where a target space (environment) is a static space to some extent, fixed map data indicating a map of the target space may be prepared in advance, but in the target space such as the factory described above, the arrangement of obstacles (such as cardboard boxes) changes according to the lapse of time, and as such it is necessary to dynamically generate (update) the map data.

In this case, the processor 31 (control module 31f) included in the information processing apparatus 3 generates a control signal for controlling the moving body 1 so as to move in the entire range in which the moving body 1 is movable in the target space. The control signal (downlink) generated by the processor 31 in this manner is output from the processor 31 (the output module 31g) to the base station 2 and transmitted from the base station 2 to the moving body 1. In this case, the control signal is received by the reception module 11 included in the moving body 1, and the control module 12 controls a moving speed and a direction of the moving body 1 based on the control signal. As a result, the moving body 1 moves entirely in the target space.

Here, the distance measurement module 13 included in the moving body 1 measures, by measuring the TOF by the LRF or the like, a distance to an object (for example, a wall, an obstacle, and the like) existing around the moving body 1 moving in the target space.

The transmission module 15 transmits, to the information processing apparatus 3 via the base station 2, map generation data (uplink) including the distance measured by the distance measurement module 13 and the moving speed and the direction of the moving body 1 controlled by the control module 12. It is noted that the map generation data is transmitted to the information processing apparatus 3 every time the moving body 1 moves based on, for example, the control signal (that is, for each point in the target space).

The map generation data transmitted from the moving body 1 (the transmission module 15) as described above is received by the base station 2 and output to the information processing apparatus 3. The processor 31 (the acquisition module 31a) included in the information processing apparatus 3 acquires the map generation data output from the base station 2. The processor 31 (the map data generation module 31b) generates map data indicating the map of the target space based on the distance and the moving speed and the direction of the moving body 1 included in the acquired map generation data. The map data generated by the processor 31 in this manner is data indicating a map such as a plan view representing a wall forming the target space, a passage through which the moving body 1 is movable, an obstacle disposed in the target space, and the like.

It is noted that the map data may be generated, for example, by updating an initial layout (map data representing only a wall and a passage) of a target space in which no obstacle or the like is disposed.

The map data generated by the processor 31 (the map data generation module 31b) as described above is stored in the storage 32.

Next, processing of generating reception power map will be described. In this case, the processor 31 (the control module 31f) included in the information processing apparatus 3 generates a control signal for controlling the moving body 1 so as to move along all the passages on the map indicated by the map data stored in the storage 32 as described above. The control signal generated in the processor 31 in this manner is output from the processor 31 (the output module 31g) to the base station 2 and transmitted from the base station 2 to the moving body 1. As a result, the moving body 1 moves entirely in the target space.

Here, in 5G (local 5G), a synchronization signal is broadcasted from the base station 2. The reception module 11 included in the moving body 1 receives the synchronization signal broadcasted from the base station 2 in this manner.

The reception power measurement module 14 measures the reception power of the synchronization signal received by the reception module 11. It is noted that the reception power measured in the present embodiment may be, for example, at least one of received signal strength indicator (RSSI), reference signal received power (RSRP), secondary synchronization signal-reference signal received power (SSS-RSRP), and primary synchronization signal-reference signal received power (PSS-RSRP).

In addition, here, it has been described that the reception power of the synchronization signal broadcasted from the base station 2 is measured, but for example, in 5G (local 5G), a plurality of reference signals such as a channel state information-reference signal (CSI-RS), which is a reference signal for channel information estimation, and a demodulation reference signal (DM-RS), which is a reference signal for demodulation are prepared. Therefore, the reception power may be measured using these reference signals. In this case, the reception power of one reference signal among a plurality of reference signals having different at least one of the frequency, the time, and the antenna may be measured, or an average value of the reception power of each of the plurality of reference signals may be measured.

The transmission module 15 transmits, to the information processing apparatus 3 via the base station 2, reception power data indicating the reception power measured by the reception power measurement module 14. It is noted that the reception power data is transmitted to the information processing apparatus 3, for example, every time the moving body 1 moves based on the control signal (for each point in the target space).

Furthermore, although detailed description is omitted here, the above-described map generation data (the distance to an object existing around the moving body 1, and the moving speed and the direction of the moving body 1) is transmitted from the moving body 1 to the information processing apparatus 3 every time the moving body 1 moves in the processing of generating the reception power map as well.

As described above, the map generation data and the reception power data transmitted from the moving body 1 (the transmission module 15) are received by the base station 2 and output to the information processing apparatus 3. The processor 31 (the acquisition module 31a) included in the information processing apparatus 3 acquires the map generation data and the reception power data output from the base station 2.

Here, the processor 31 can acquire (grasp) the position of the moving body 1 on the map indicated by the map data based on the distance to the object existing around the moving body 1 and the moving speed and the direction of the moving body 1 included in the map generation data. The processor 31 (the reception power map generation module 31c) generates a reception power map (a heat map of the reception power at each point where the moving body 1 is located) obtained by mapping the position of the moving body 1 and the reception power indicated by the reception power data acquired in this manner. Specifically, the processor 31 generates a reception power map (a radio wave map indicating a propagation environment of a radio wave in a target space) by allocating (that is, a point and reception power are associated with each other) the reception power measured at each point by the movement of the moving body 1 to (a pixel corresponding to) the point. It is noted that, in a case where a person intervenes in the control on the information processing apparatus 3 (MEC) side, a reception power map in a visually recognizable mode may be generated.

The reception power map generated by the processor 31 (the reception power map generation module 31c) as described above is stored in the storage 32.

It is noted that, in the processing of generating the reception power map, the map generation data is used to acquire a point (a position) to which the reception power indicated by the reception power data is allocated, but the map generation data may be further used to update the map data (that is, arrangement of obstacles, and the like) stored in the storage 32 described above.

In addition, although it has been described here that the reception power map is generated based on the reception power of the downlink signal (the synchronization signal), in general, since there is duality (a symmetrical relationship) between the downlink and the uplink in wireless communication, the reception power map may be generated based on the reception power of the uplink signal, or may be generated based on a result of merging the reception power of the downlink signal and the reception power of the uplink signal.

In the present embodiment, the processing of generating the map data and the processing of generating the reception power map have been separately described (that is, the description has been given assuming that the reception power map is generated after the map data is generated), but the map data and the reception power map may be generated simultaneously (in parallel).

Furthermore, in the present embodiment, as long as the propagation environment of the signal (the radio wave) in the target space can be grasped, a map in which a throughput and a bit error rate of a signal are assigned to each point on the map may be generated instead of the reception power map.

Furthermore, for example, in a case where an obstacle (for example, a radio wave shielding object or the like) disposed in the target space at a timing of preliminary measurement is known by preliminary measurement or the like before the moving body control system is operated, information such as the position of the obstacle may be registered (stored) in the map data and the reception power map described above.

When the processing in step S1 is executed, the operation of the moving body control system can be started. In this case, the processor 31 (the control module 31f) included in the information processing apparatus 3 selects a route on which the moving body 1 moves in the target space based on the map data and the reception power map stored in the storage 32 (step S2).

In step S2, the processor 31, for example, performs cost calculation considering reception power in a space overlapping each of a plurality of routes from a start point to a goal point set on a map indicated by map data, and selects an optimum route from among the plurality of routes based on a result of the cost calculation.

Hereinafter, cost calculation for selecting a route will be briefly described. First, the processor 31 refers to the reception power map and acquires reception power (reception power map information) allocated to each point (pixel) corresponding to each of a plurality of routes (a shortest route, an intermediate route, a longest route, and the like) from a start point to a goal point. The processor 31 classifies the acquired reception power into “strong”, “medium”, and “weak” based on a plurality of threshold values prepared in advance. In this case, for example, a value (cost) corresponding to “strong” is set to 1, a value (cost) corresponding to “medium” is set to 2, and a value (cost) corresponding to “weak” is set to 3, and the processor 31 calculates the cost of each route by adding, for each route, a value corresponding to a result (“strong”, “medium” or “weak”) obtained by classifying the reception power allocated to each point corresponding to each route. The processor 31 selects, for example, a route having the lowest cost calculated in this manner.

According to such cost calculation, for example, when a dead zone is not generated in a target space, the cost of the shortest route is the lowest, and as such the shortest route is selected. On the other hand, for example, in a case where a space (that is, the dead zone in which the reception power decreases) in which a propagation environment of a signal deteriorates is generated on the shortest route, the cost of the shortest route increases, and as such, for example, the intermediate route is selected.

It is noted that, for example, it is conceivable to suppress a decrease in the reception power in the dead zone by using time diversity, frequency diversity, or spatial diversity. However, in the present embodiment, it is assumed that a priority is given to more stable operation (motion) of the moving body 1 and a route avoiding the dead zone is selected.

When the processing in step S2 is executed, the processor 31 (the control module 31f) controls the moving body 1 so as to move along the route selected in step S2 (step S3). The control of the moving body 1 in step S3 is implemented by outputting, to the base station 2, a control signal for controlling the moving body 1 generated by the processor 31 and transmitting, to the moving body 1, the control signal from the base station 2.

Here, in a case where the processing in step S3 described above is executed, the moving body 1 moves from the start point to the goal point along the route selected in step S2, and the moving body 1 transmits the map generation data and the reception power data described above to the information processing apparatus 3 via the base station 2 at each point while moving along the route.

In this case, the processor 31 (the acquisition module 31a) included in the information processing apparatus 3 acquires, from the base station 2, the map generation data and the reception power data transmitted from the moving body 1 that has moved along the route selected in step S2 (step S4).

When the processing in step S4 is executed, the processor 31 (the map data generation module 31b) updates the map data stored in the storage 32 based on the map generation data acquired in step S4 (step S5). It is noted that, since only the map generation data on the route selected in step S2 is acquired in step S4, only the peripheral portion of the route in the map indicated by the map data is updated in step S5.

Furthermore, the processor 31 (the reception power map generation module 31c) updates the reception power map stored in the storage 32 based on the map generation data and the reception power data acquired in step S4 (step S6).

Here, assuming that a route for avoiding the dead zone (for example, the dead zone 1h illustrated in FIG. 3) where the reception power decreases is selected in step S2 described above, only the map generation data and the reception power data on the route selected in step S2 are acquired in step S4, and as such only the reception power allocated to each point on the route of the reception power map is updated in step S6.

That is, in the reception power map updated in step S6 described above, it is not possible to determine whether the dead zone on the route where the moving body 1 does not move is eliminated.

It is noted that the dead zone is eliminated, for example, by removing an obstacle, but the moving body 1 in the present embodiment may be able to detect the presence or absence of the obstacle by the LRF. However, since the LRF cannot determine the height of an obstacle, for example, even if an obstacle is detected by the LRF, for example, the dead zone may be eliminated when the height of the obstacle is low. Furthermore, for example, even if an obstacle is detected by the LRF, the dead zone may be eliminated in a case where the obstacle is not a radio wave shielding object. That is, it is difficult to estimate the elimination of the dead zone by the LRF (that is, the propagation environment of the signal in the dead zone generated in the past).

Therefore, in the present embodiment, focusing on the periodicity of the reception power indicated by the reception power data received in step S4, the processor 31 (the calculation module 31d and the determination module 31e) executes processing of detecting an obstacle (a radio wave shielding object having a height that affects a signal propagation environment) in a space facing the antenna installed in the base station 2 across a point where the reception power is measured (step S7).

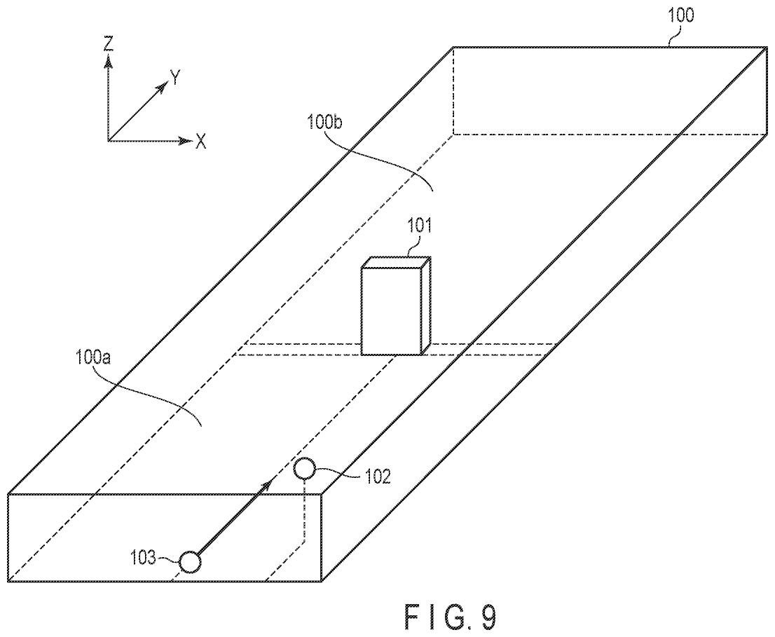

Hereinafter, the principle of detecting an obstacle in step S7 will be described. First, reception power (data) used to detect an obstacle will be described with reference to a simulation model illustrated in FIG. 9.

As the simulation model illustrated in FIG. 9, for example, it is assumed that a room model 100 of 9 m (in the X-axis direction)×18 m (in the Y-axis direction)×3 m (in the Z-axis direction) is generated. It is assumed that an obstacle (for example, a radio wave shielding object formed of metal or the like) 101 of, for example, 2 m (in the X-axis direction)×1 m (in the Y-axis direction)×3 m (in the Z-axis direction) can be disposed in the vicinity of the center of the room model 100.

A transmission point 102 imitating an antenna installed in the base station 2 is disposed near the ceiling of such a room model 100, and radio wave propagation between the transmission point 102 and a reception point 103 imitating the moving body 1 (the radio device) is grasped by ray tracing. It is noted that ray tracing means, for example, tracking of a route (path) through which a signal transmitted from the transmission point 102 reaches the reception point 103. According to this ray tracing, it is possible to obtain the reception power of the signal received at the reception point 103 via all routes in consideration of the attenuation, phase, and the like of the signal.

It is noted that, in the ray tracing based on the room model 100, an electrical constant is set on the assumption that the wall surface is made of concrete, and a route in which the number of reflections on the wall surface is up to 5 is tracked.

Here, it is assumed that the reception point 103 moves in the Y-axis direction along the ground of the room model 100, and reception power measured in an area 100a (that is, an area that is not affected by the obstacle 101) sandwiched between the transmission point 102 and the obstacle 101 is compared with reception power measured in an area 100b (that is, an area that is affected by the obstacle 101) located on the back side of the obstacle 101 when viewed from the transmission point 102.

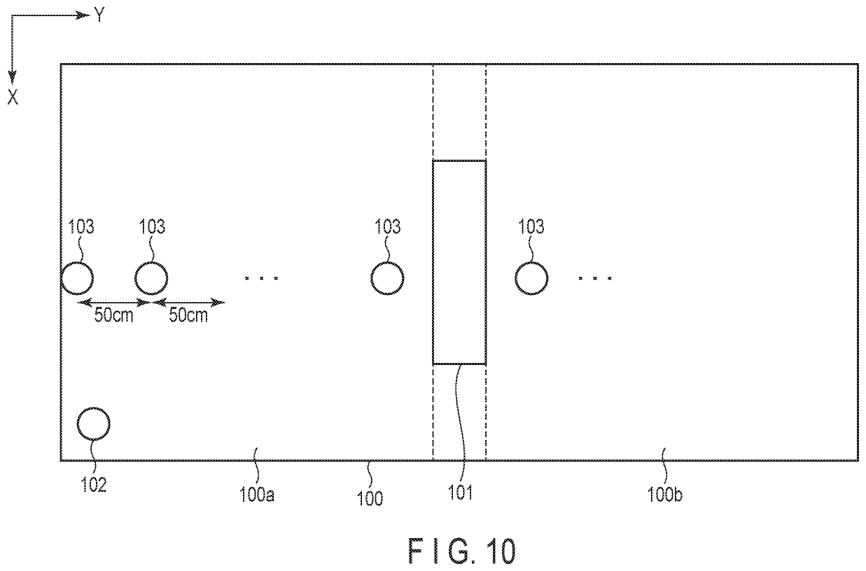

FIG. 10 is a plan view illustrating a positional relationship among the obstacle 101, the transmission point 102, and the reception point 103 in the room model 100 illustrated in FIG. 9. FIG. 10 assumes a case in which the reception points 103 are arranged at intervals of 50 cm in the Y-axis direction (that is, the reception power is measured every time the reception point 103 moves by 50 cm).

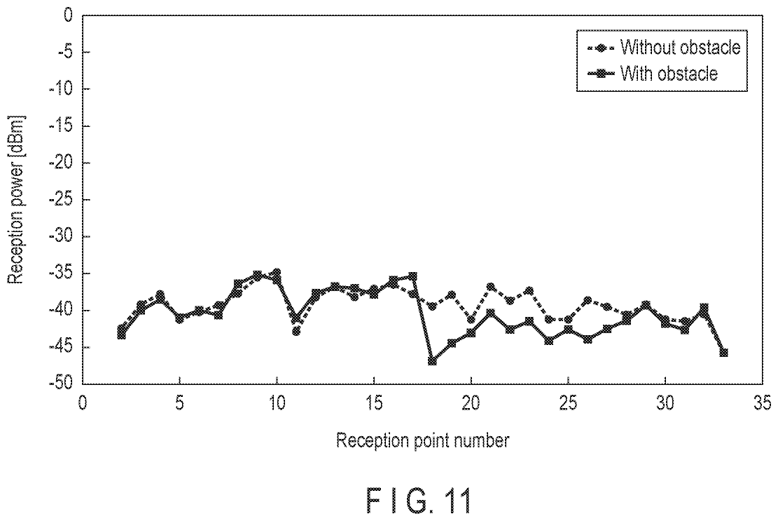

FIG. 11 illustrates transition of the reception power (that is, a simulation result in the room model 100) measured at each reception point 103 disposed as illustrated in FIG. 10. It is noted that, in order to simply simulate wide-band communication, an average value of the reception power of signals in a plurality of frequency bands (for example, 4.8 GHZ, 4.825 GHz, 4.85 GHz, 4.875 GHz, 4.9 GHz, and the like) is used as the reception power illustrated in FIG. 11. It is noted that FIG. 11 illustrates the reception power measured at the reception point 103 in association with each number assigned to each of the reception points 103 (hereinafter, referred to as a reception point number). In the example illustrated in FIG. 11, the reception point number assigned to the reception point 103 disposed at a position closest to the obstacle 101 in the area 100a is 17, and the reception point number assigned to the reception point 103 disposed at a position closest to the obstacle 101 in the area 100b is 18. In other words, it is assumed that the obstacle 101 is disposed between the reception point 103 having the reception point number 17 and the reception point 103 having the reception point number 18.

According to this configuration, although there is a large difference, depending on the presence or absence of the obstacle 101, in the reception power measured at the reception points 103 having the reception point number of 18 or the subsequent number, which exist at the back of the obstacle 101 when viewed from the transmission point 102, it is not possible to confirm a large difference, depending on the presence or absence of the obstacle 101, in the reception power measured at the reception point 103 in front of the obstacle 101.

That is, in the present embodiment, as described above, it is necessary to detect the obstacle 101 (to estimate whether the obstacle 101 has been removed) on the area 100a side without entering the space (that is, the area 100b) on the back side of the obstacle 101 when viewed from the transmission point 102. However, as described above, it is difficult to perform the detection with high accuracy only by comparing the reception power measured on the area 100a side.

Therefore, in the present embodiment, it is assumed that the above-described broadband communication is realized from a plurality of independent narrow-band frequencies (channels), and reception power that can be measured finely in terms of location is effectively used.

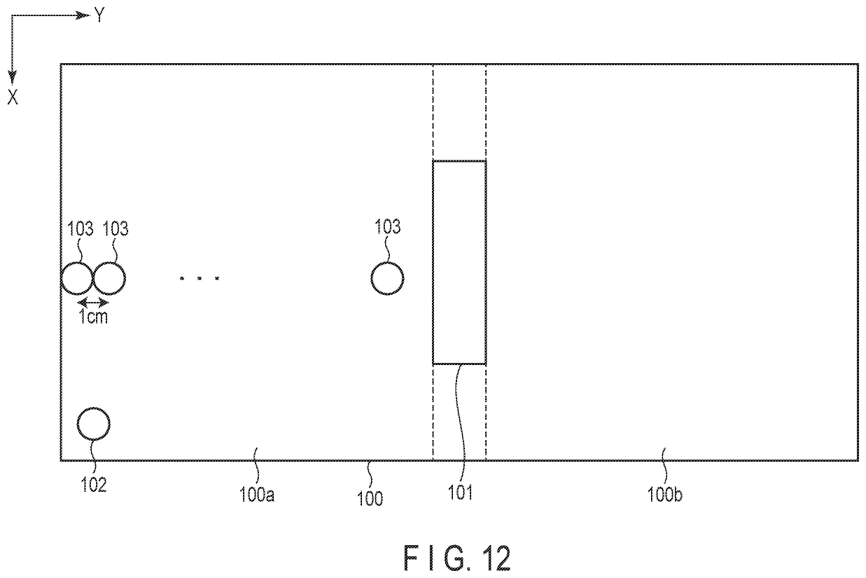

Here, as illustrated in FIG. 12, it is assumed that the reception points 103 are arranged at intervals of 1 cm in the Y-axis direction (that is, the reception power is measured every time the reception point 103 moves by 1 cm).

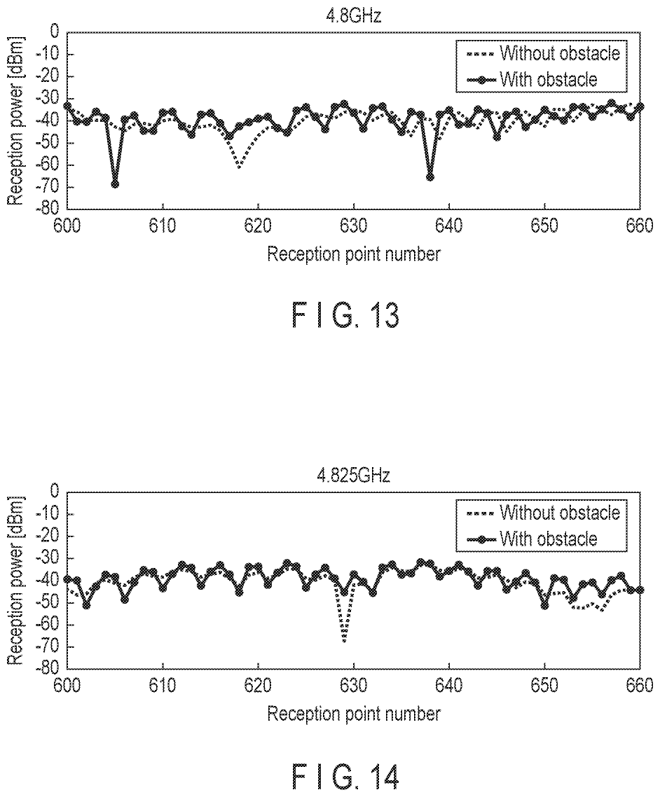

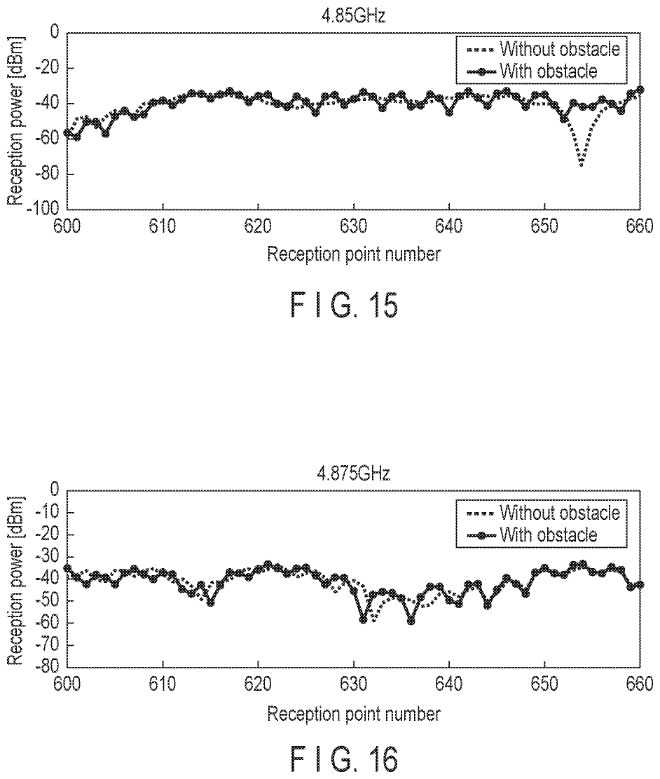

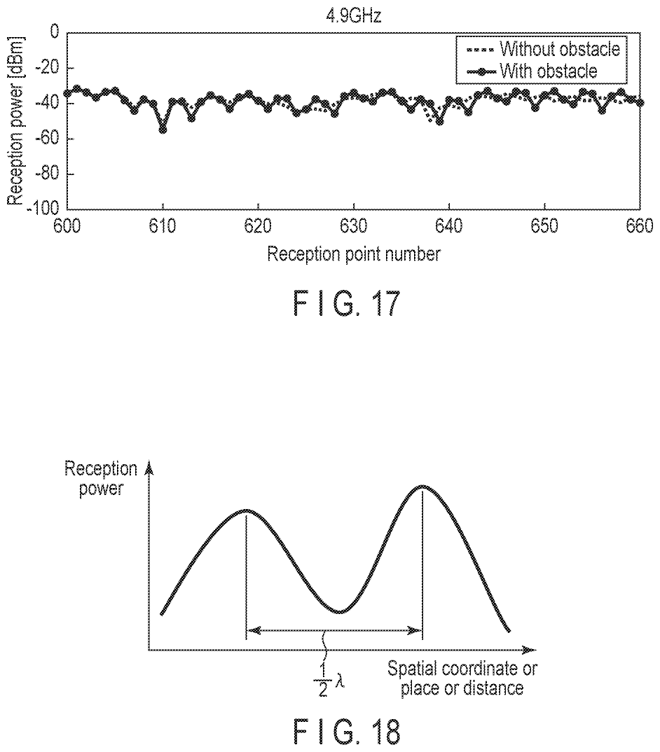

In addition, FIGS. 13 to 17 illustrate the transition of the reception power of each signal of the plurality of narrow-band frequencies described above. Specifically, FIG. 13 illustrates the transition of reception power of a signal of 4.8 GHZ. FIG. 14 illustrates the transition of reception power of a signal of 4.825 GHz. FIG. 15 illustrates the transition of reception power of a signal of 4.85 GHZ. FIG. 16 illustrates the transition of reception power of a signal of 4.875 GHz. FIG. 17 illustrates the transition of reception power of a signal of 4.9 GHZ.

It is noted that, in FIGS. 13 to 17, only the reception power measured at the reception point 103 disposed on the area 100a side is illustrated for convenience.

According to FIGS. 13 to 17, as compared with a case in which the obstacle 101 does not exist, the reception power measured at each reception point 103 in the case in which the obstacle 101 exists fluctuates little by little, and there is a possibility that a difference based on the presence or absence of the obstacle 101 can be grasped by using the concept of a spatial frequency described later.

In the present embodiment, for example, it is conceivable to utilize phase information of a radio wave propagation path that can be acquired by using a channel sounder or the like capable of measuring or evaluating a radio wave propagation characteristic. However, from a viewpoint of simplicity of measurement, a configuration using only reception power is adopted.

Furthermore, here, the reception points 103 have been described as being arranged at intervals of, for example, 1 cm, but as illustrated in FIG. 18, a cycle of a half wavelength (that is, ½ of wavelength A) of the radio wave is a guide for the intensity of the reception power. For this reason, when it is considered that the above-described small fluctuation in the reception power similarly occurs with the cycle of the half wavelength of the radio wave as a guide, the reception power may be measured at intervals shorter than the half wavelength of the radio wave so that the fluctuation can be grasped (followed).

Specifically, for example, since the wavelength of the radio wave radiated at 4.8 GHz is 6 cm, the half wavelength of the radio wave is 3 cm. In this case, for example, by measuring the reception power at intervals of about 1 cm shorter than the half wavelength of the radio wave as described above, it is considered that it is possible to grasp the small fluctuation in the reception power.

Next, a point (a reception power collection range) where reception power used to detect an obstacle is measured will be described based on the knowledge obtained by the above-described ray tracing.

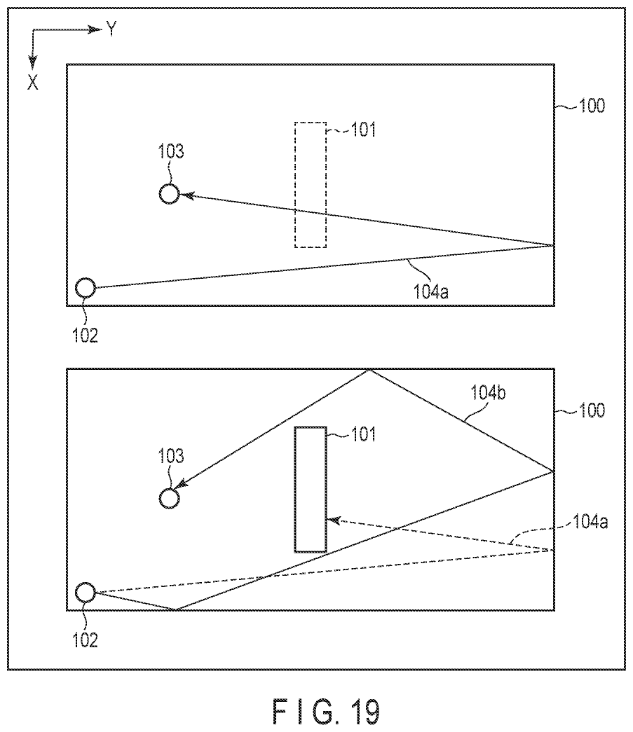

Here, the upper part of FIG. 19 illustrates the room model 100 in which the obstacle (the radio wave shielding object) 101 does not exist, and the lower part of FIG. 19 illustrates the room model 100 in which the obstacle (the radio wave shielding object) 101 exists.

According to the upper part of FIG. 19, in the room model 100 in which the obstacle 101 does not exist, for example, a route 104a exists as a route through which a signal transmitted from the transmission point 102 reaches the reception point 103. On the other hand, according to the lower part of FIG. 19, in the room model 100 in which the obstacle 101 exists, for example, the above-described route 104a does not exist as a route through which the signal transmitted from the transmission point 102 reaches the reception point 103, and the signal reaches the reception point 103 via a long route such as a route 104b.

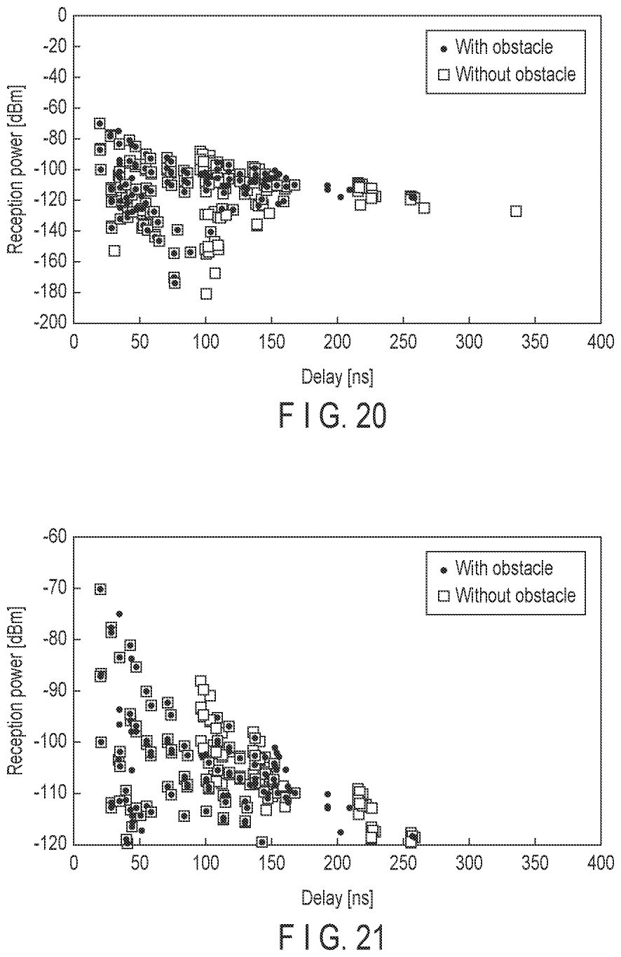

Furthermore, FIG. 20 illustrates a delay profile (a distribution of a delayed wave) of a signal received at each of the reception points 103 disposed at the same point on the area 100a side in the room model 100 illustrated in the upper part of FIG. 19 and the room model 100 illustrated in the lower part of FIG. 19. The delay profile illustrated in FIG. 20, shows, for example, a correspondence relationship, for each of the plurality of routes through which the signal of 4.8 GHz reaches the reception point 103 from the transmission point 102, between the delay of the signal (time from transmission to reception of the signal) and the reception power of the signal. It is noted that FIG. 21 is an enlarged view of a part of the delay profile illustrated in FIG. 20.

According to FIGS. 20 and 21, the reception power is high when the obstacle 101 does not exist in the vicinity of the delay of 100 ns. This is due to the influence of the route 104a illustrated in the upper part of FIG. 19, and it is considered that the signal (the radio wave) reflected only once on the wall surface was received with a relatively short delay and a high intensity.

That is, while it is considered that the above-described small fluctuation in the reception power is generated by a change in an arrival route of the signal due to the presence of the obstacle 101, a place where the fluctuation is likely to occur can be estimated based on the delay profile. In addition, it can be said that delay profile characteristics illustrated in FIGS. 20 and 21 indicate that a dominant reflected wave becomes weak due to the arrangement of the obstacle 101 and a relatively multipath rich environment is made (that is, multipath tendency). According to this configuration, in the present embodiment, by using the reception power measured at each point in the target space determined based on the delay profile (that is, the distribution of the delayed wave), it is considered that it is possible to efficiently grasp a small fluctuation in the reception power useful for detecting an obstacle. It is noted that, since the intensity of the reception power in the multipath environment is based on the cycle of the half wavelength of the radio wave as described above, each point where the reception power is measured is determined to have an interval shorter than the half wavelength of the radio wave.

In consideration of the above description, in the present embodiment, it is assumed that the reception power is measured at at least two or more points at the time of moving a distance of a half wavelength of a center frequency used in communication between the moving body 1 and the base station 2, and an obstacle is detected using the measured reception power (that is, the fluctuation in the reception power is tracked).

In addition, it is assumed that a point where reception power used to detect an obstacle is measured (hereinafter, referred to as a measurement target point) is, for example, a point in a space where no obstacle (the radio wave shielding object) is disposed between the moving body 1 and the base station 2, such as the area 100a illustrated in FIG. 9. That is, the measurement target point is basically a point in space that can be seen from the base station 2 (the antenna). However, for example, even in a case where the moving body 1 is out of sight when viewed from the base station 2 due to the presence of an obstacle such as an empty cardboard box, since the obstacle is not the radio wave shielding object, a point in the space facing the base station 2 across the obstacle is also included in the measurement target point. That is, it is assumed that the obstacle detected in the present embodiment is the radio wave shielding object. It is noted that the measurement target point may be determined in consideration of, for example, a position of a known obstacle and a delay profile (a distribution of a delayed wave) registered in the map data and the reception power map.

In addition, in the present embodiment, as described above, detection performance for the obstacle (the radio wave shielding object) in the multipath environment is improved by measuring the reception power by spatially increasing resolution using the half wavelength or less of the radio wave used for communication as a guide to follow the fluctuation in the reception power. In addition, in the present embodiment, by using the reception power measured at the measurement target point (that is, an area having a high radio field intensity) where the visibility from the base station 2 is good, it is not necessary to move the moving body 1 to, for example, a space having a high possibility of a dead zone, and thus, it is possible to avoid unstable control of the moving body 1 (that is, the control signal transmitted from the base station 2 is not normally received).

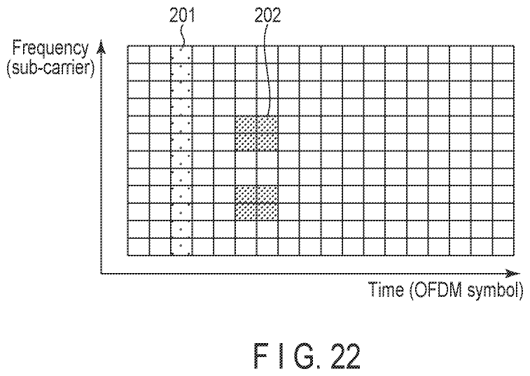

Furthermore, in the present embodiment, an obstacle is detected using reception power of a narrow-band signal. It is noted that the narrow band in the present embodiment refers to a band that is narrow to such an extent that the channel is frequency non-selective. In the present embodiment, “the channel is frequency non-selective” means that, for example, there is no power fluctuation due to the frequency or the power fluctuation due to the frequency is equal to or less than a predetermined value or equal to or less than a threshold value. An example of the narrow band is one subcarrier unit of orthogonal frequency-division multiplexing (OFDM). In the present embodiment, even in a case where broadband communication is executed between the moving body 1 and the base station 2, it is sufficient that reception power of a signal of a part of the broadband (the narrow band) can be measured and used. In 5G, reference signals such as CSI-RS 201 and DM-RS 202 are defined as illustrated in FIG. 22, and the reception power for each subcarrier can be measured using the reference signals.

The reception power used to detect the obstacle may be the reception power of the signal of at least one subcarrier (the narrow band), but may be the reception power of the signals of a plurality of subcarriers. Furthermore, although the reception power of the signal for each subcarrier is used in the description here, the reception power of the signal for each subcarrier may be further acquired for each time. Furthermore, in a case where the number of antennas is two or more, the reception power of the signal for each subcarrier may be further acquired for each antenna.

Under the multipath environment, the influence of the multipath can be alleviated by calculating average reception power using a broadband signal. However, with such average reception power, it is difficult to detect a fluctuation in a route (a radio wave propagation path) through which a signal reaches a reception point from a transmission point. Therefore, in the present embodiment, the detection performance for the fluctuation in the radio wave propagation path (that is, the fluctuation in the reception power) is improved by using the narrow-band signal.

Here, in the present embodiment, the obstacle is detected using the periodicity of the reception power (the reception power slightly fluctuates when the obstacle exists), but the concept of the spatial frequency is used to quantify the periodicity of the reception power.

Hereinafter, the spatial frequency will be described. For example, when considering a grayscale image in which black represents a high intensity and white represents a low intensity (an image in which the intensity is expressed by black and white shading), the shading can be regarded as a wave. According to such an idea, any grayscale image can be expressed by adding waves. Therefore, similarly to the Fourier transform that decomposes a time waveform into a frequency component, it is possible to decompose shading (that is, spatial shading) representing the intensity of the spatial reception power into a spatial frequency component. It is noted that the spatial frequency (spatial frequency) can be mutually converted into a spatial wave number (spatial wave number) and a spatial wavelength (spatial wavelength).

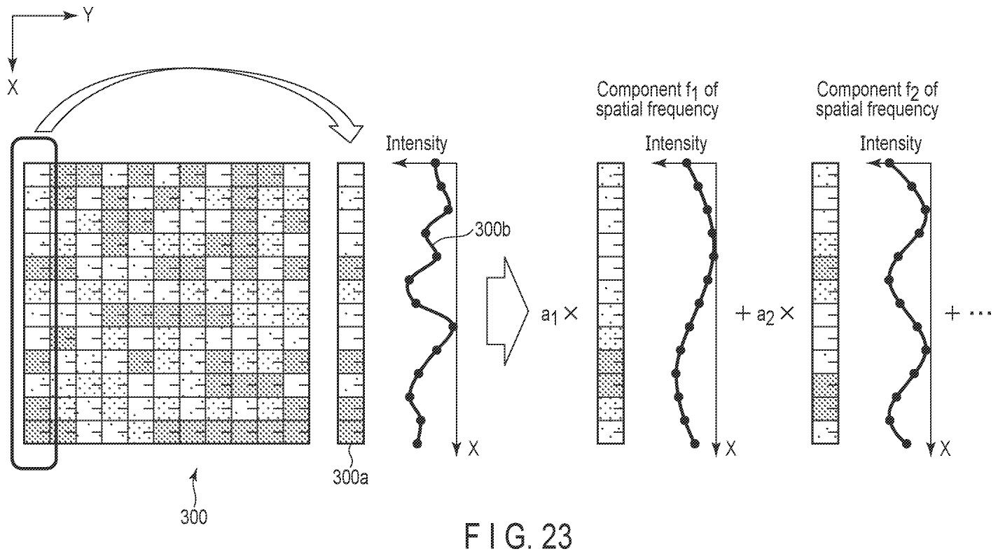

Here, FIG. 23 illustrates a reception power map (a radio wave map) 300 in which spatial reception power (radio field intensity) is represented in gray scale (black-and-white shading). The reception power map 300 illustrated in FIG. 23 is two-dimensional map, but is one-dimensional extension, and thus, one row (hereinafter, referred to as a reception power train 300a) of the reception power map 300 is extracted and considered one-dimensional map. It is noted that the same concept can be applied even in two dimensions.

Here, when reception power (radio field intensity) in the reception power train 300a is represented in a graph form and the reception power represented in the graph form is captured as a waveform 300b, the waveform 300b (the reception power train 300a) can be expressed by adding components of respective spatial frequencies, such as “component amount a₁ of component f₁ of spatial frequency x component f₁ of spatial frequency+component amount a₂ of component f₂ of spatial frequency×component f₂ of spatial frequency+ . . . ”.

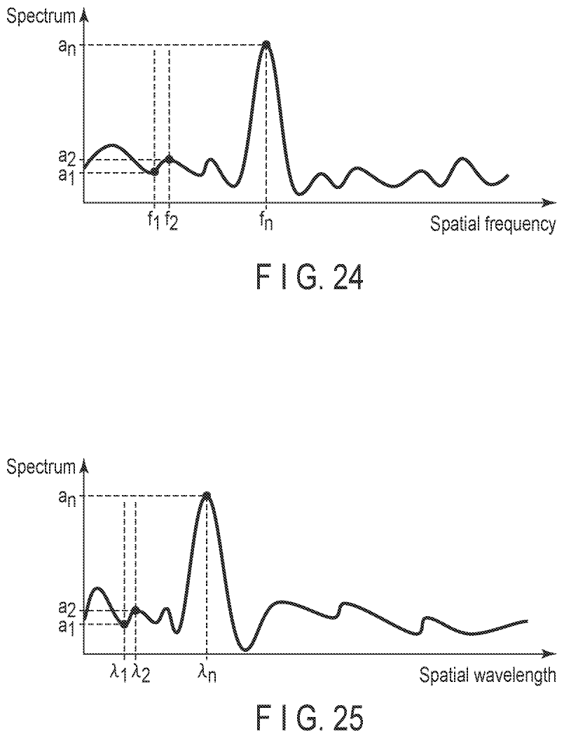

Here, FIG. 24 illustrates an example of spectrum display in which (the component of) the spatial frequency is on the horizontal axis and the component amount of the component of the spatial frequency is on the vertical axis. In the spectrum display illustrated in FIG. 24, a component amount an at the time of a component fₙ of the spatial frequency becomes a peak, and it can be seen that the component fₙ of the spatial frequency is dominant in the spatial distribution of the reception power (the radio field intensity) in the reception power train 300a (the waveform 300b). Although FIG. 24 illustrates an example in which the spatial frequency is on the horizontal axis, for example, as illustrated in FIG. 25, the horizontal axis may be a spatial wavelength converted from the spatial frequency. In this case, the dominant wavelength in the spatial distribution of the reception power in the reception power train 300a (the waveform 300b) can be seen.

In a case where the above-described spectrum display is applied to the spatial distribution of the reception power (the spatial distribution of the reception power) illustrated in FIGS. 13 to 17, it is expected that a change in the dominant spatial frequency (or the spatial wavelength) according to the presence or absence of an obstacle (a radio wave shielding object) can be grasped.

Hereinafter, an example of a method of calculating the spectrum of the spatial frequency described above will be described. As described above, the spatial frequency can be mutually converted into the spatial wave number and the spatial wavelength. In other words, the spatial frequency can be expressed by the spatial wave number and the spatial wavelength, respectively. In the present embodiment, a description will be basically unified to the spatial frequency which is a general expression, but the expression of the spatial wave number and the spatial wavelength is used in the case of clearly distinguishing from the normal wave number and the wavelength.

Here, spectrum Y (k) of the spatial frequency is expressed by the following Formula (1).

$$\\ \begin{matrix}Y ( k ) = \frac{1}{N} {\sum }_{n = 0}^{N - 1} y ( n ) {e}^{{}_{} - {jkx}_{n}} & Formula ( 1 )\end{matrix}$$

In Formula (1), n is a sample (reception point at which reception power is measured), N is the total number of samples, j is an imaginary unit, and xₙ is a distance corresponding to the sample n. k is a spatial wave number and is represented by 2Π/λ. Further, y(n) is reception power measured in the sample (reception point) n. It is noted that A is a spatial wavelength and is different from a wavelength with respect to a carrier frequency.

When Formula (1) is displayed in detail by shifting the spatial wave number k from k₁ to kₘ, the following Formula (2) is obtained.

$$\\ \begin{matrix}Y ( {k}_{1} ) = \frac{1}{N} ( y ( 0 ) {e}^{{}_{} - {jk}_{1} {x}_{0}} + y ( 1 ) {e}^{{}_{} - {jk}_{1} {x}_{1}} + … + y ( N - 1 ) {e}^{{}_{} - {jk}_{1} {x}_{N - 1}} ) & Formula ( 2 )\end{matrix}$$

$$\\ Y ( {k}_{2} ) = \frac{1}{N} ( y ( 0 ) {e}^{{}_{} - {jk}_{2} {x}_{0}} + y ( 1 ) {e}^{{}_{} - {jk}_{2} {x}_{1}} + … + y ( N - 1 ) {e}^{{}_{} - {jk}_{2} {x}_{N - 1}} )$$

$$\\ \\ Y ( {k}_{m} ) = \frac{1}{N} ( y ( 0 ) {e}^{{}_{} - {jk}_{m} {x}_{0}} + y ( 1 ) {e}^{{}_{} - {jk}_{m} {x}_{1}} + … + y ( N - 1 ) {e}^{{}_{} - {jk}_{m} {x}_{N - 1}} )$$

Next, it is considered to link the Formulas (1) and (2) with the spatial distribution of the reception power illustrated in FIGS. 13 to 17. Here, for example, it is assumed that reception power of a signal of 4.825 GHz is measured at a reception point having a reception point number of 600 to 660 illustrated in FIG. 14, and a spectrum of a spatial frequency is calculated using the measured reception power. In this case, the number of samples n is 61 (That is, N=61) up to 0 to 60, and the reception power measured in each of the samples n is y(0) to y(60). When the reception power is dBm as indicated by the vertical axis in FIG. 14, the reception power converted to a true value is used as y(n). It is noted that the true value is obtained by calculating 10 (X/10) where the reception power (dBm) is defined as X. In addition, as described with reference to FIG. 12, in a case where the samples (reception points) n are arranged at intervals of 1 cm, xₙ in Formula (1) is a distance having resolution of 1 cm.

In this case, Y(k) is calculated while shifting the spatial frequency from k₁ to kₘ as in Formula (2). However, since it is not easy to grasp the characteristics of the spectrum in the state of the spatial wave number, the spatial wavelength (λ=2Π/k) converted from the spatial wave number is used. That is, the spatial wavelength is shifted (changed) from λ₁ to λₘ, and Y(k₁), Y(k₂), . . . , and Y(kₘ) in Formula (2) are calculated from k₁=2Π/λ₁, k₂=2Π/λ₂, . . . , and kₘ=2Π/λₘ at that time. It is noted that, since k₁, k₂, . . . , and kₘ are actually functions of λ₁, λ₂, . . . , and λₘ, calculating Y(k₁), Y(k₂), . . . , and Y(kₘ) corresponds to calculating Y(λ₁), Y(λ₂), . . . , and Y(λₘ).

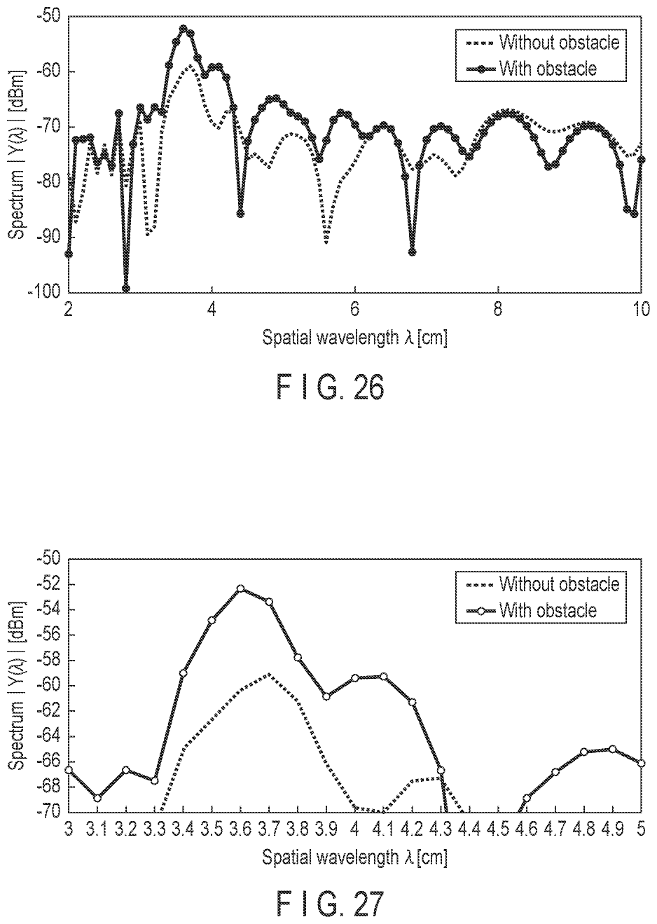

FIG. 26 illustrates a relationship between the spectra Y(λ₁), Y(λ₂), . . . , and Y(λₘ) of the spatial frequencies calculated as described above and λ₁, λ₂, . . . , and λₘ. It is noted that, in FIG. 26, Y(λ₁), Y(λ₂), . . . , and Y(λₘ) are not true values but dBm obtained by taking logarithms. FIG. 27 is an enlarged view of a part of FIG. 26. According to FIGS. 26 and 27, it can be seen that there are more components having a shorter spatial wavelength in the presence of an obstacle.

Here, as described above, in the multipath environment, the cycle of the intensity (magnitude) of the reception power is roughly a half wavelength of the radio wave. For example, in a case where a frequency of a signal (a radio wave) is 4.825 GHz, since a half wavelength of the radio wave is 3.1 cm, the spatial wavelength in the vicinity of 3.1 cm illustrated in FIGS. 26 and 27 is referred to. According to this configuration, although there is a slight deviation, when an obstacle (a radio wave shielding object) exists, there is a peak around 3.6 cm in the spatial wavelength, and it can be said that there is a significant difference from a case in which no obstacle exists.

In step S7 illustrated in FIG. 8, the calculation module 31d calculates the spectrum of the spatial frequency from the reception power (the spatial distribution of the reception power) indicated by the reception power data received in step S4. In other words, the calculation module 31d decomposes the spatial distribution of the reception power into the components of the spatial frequency. It is noted that the spectrum in the present embodiment is calculated in a range from ¼ wavelength to one wavelength of the radio wave used in the communication between the moving body 1 and the base station 2, but the range may be a range including at least ½ wavelength.

It is noted that the calculation module 31d may calculate only the peak value of the spatial frequency, the spatial wave number, or the spatial wavelength spectrum.

In the present embodiment, by applying such a concept of the spatial frequency, it is possible to quantify the small spatial fluctuation in the reception power described above with reference to FIGS. 13 to 17, and as such it is possible to clarify detection criterion for the obstacle (the radio wave shielding object). Furthermore, it is possible to improve obstacle detection performance by referring to a component near a half wavelength of a radio wave used for communication between the moving body 1 and the base station 2.

Here, in the present embodiment, the storage 32 included in the information processing apparatus 3 stores (the reception power data indicating) past reception power measured at each point in the target space and, for example, at the point in a state where no obstacle exists. In this case, the calculation module 31d can calculate the spectrum of the past spatial frequency (hereinafter, referred to as a first spatial frequency spectrum) based on the reception power stored in the storage 32 in association with the measurement target point. It is noted that the reception power for calculating the first spatial frequency spectrum may be acquired from, for example, the reception power map (the reception power allocated to each point). In the present embodiment, the determination module 31e compares the first spatial frequency spectrum calculated in this manner with a spectrum (hereinafter, referred to as a second spatial frequency spectrum) of the current spatial frequency calculated based on the reception power indicated by the reception power data acquired in step S4, thereby determining the presence or absence of (the influence of) the obstacle.

Specifically, assuming that the first spatial frequency spectrum is calculated based on the reception power measured in a state where no obstacle exists as described above, the determination module 31e determines that the obstacle exists when there is a significant difference between the first spatial frequency spectrum and the second spatial frequency spectrum. On the other hand, when there is no significant difference between the first spatial frequency spectrum and the second spatial frequency spectrum, the determination module 31e determines that no obstacle exists. It is noted that “there is a significant difference between the first spatial frequency spectrum and the second spatial frequency spectrum” includes, for example, the fact that a difference between a peak value in the first spatial frequency spectrum and a peak value in the second spatial frequency spectrum corresponding to a spatial wavelength near a half wavelength of a radio wave is outside a predetermined range set from a viewpoint that the first spatial frequency spectrum and the second spatial frequency spectrum can be different. However, the present embodiment may be a configuration in which the presence or absence of an obstacle is determined by focusing on a difference in the spatial frequency spectrum depending on the presence or absence of the obstacle, and whether there is a significant difference between the spatial frequency spectra can be determined by applying various methods.

In addition, here, the first spatial frequency spectrum has been described as being calculated based on the past reception power stored in the storage 32, but the storage 32 may store, for example, the first spatial frequency spectrum calculated in advance.

As described above, the second spatial frequency spectrum is calculated based on the current reception power measured at the measurement target point, but the first spatial frequency spectrum is preferably calculated based on the past reception power measured at the measurement target point (that is, the same reception point as the second spatial frequency spectrum). According to this configuration, by comparing the spatial frequency spectra of the same points (positions), higher determination accuracy can be achieved.

However, even when there is no reception power measured at the same point, it is possible to substitute the reception power measured at different points within a half wavelength as long as the resolution is the same. That is, the same point in the present embodiment includes a case in which a distance between points is less than a predetermined value.

In addition, the first spatial frequency spectrum may be any data as long as it is possible to determine the presence or absence of an obstacle by comparing the first spatial frequency spectrum with the second spatial frequency spectrum, and may be, for example, a spectrum of a past spatial frequency calculated based on the reception power measured in a state where an obstacle exists. In this case, for example, when there is a significant difference between the first spatial frequency spectrum and the second spatial frequency spectrum, it can be determined that no obstacle exists. Furthermore, the first spatial frequency spectrum may be prepared in advance by, for example, preliminary measurement before operating (that is, the moving body 1 moves in the target space) the moving body control system.

It is noted that, in the present embodiment, it has been described that the presence or absence of an obstacle is determined (an obstacle is detected) based on a spectrum of a spatial frequency calculated based on a spatial distribution of reception power. However, the spectrum is an example representing the periodicity of the reception power, and the present embodiment may be a configuration in which the presence or absence of the obstacle is determined based on the periodicity of the reception power.

When the processing in step S7 is executed, the processor 31 (the control module 31f) reflects a detection result (that is, a determination result of the presence or absence of the obstacle) of the obstacle in step S7 in the reception power map stored in the storage 32 (step S8). Specifically, in step S8, when no obstacle is detected in step S7 described above, it is estimated that the propagation environment of the signal in the space facing the base station 2 across the moving body 1 is improved (that is, the dead zone generated by the obstacle is eliminated), and processing of updating the reception power map is executed so as to increase the reception power allocated to a point corresponding to the space. It is noted that, as described above, in a case where it is estimated that a dead zone generated by an obstacle has been eliminated, the reception power allocated to the point corresponding to the space may be deleted. According to this configuration, it is possible to select a route passing through the space by performing cost calculation in which the cost is set to zero when there is no reception power.

When the processing in step S8 described above is executed, the processing returns to step S2 and the processing is repeated. According to this configuration, for example, in a case where a dead zone is generated in the reception power map updated in step S6 due to a newly disposed obstacle, a route that avoids the dead zone is selected in step S2 that is repeatedly executed. In addition, in step S2 described above, a route avoiding the dead zone is selected, but in a case where it is estimated that the dead zone has been eliminated (that is, the fact that the propagation environment of the signal is improved due to the absence of the detection of the obstacle is reflected in the reception power map), in step S2 that is repeatedly executed, a route passing through the space that has been the dead zone can be selected.

It is noted that, in FIG. 8, for example, a situation is assumed in which the moving body 1 repeatedly moves along a route from a start point to a goal point set on a map indicated by map data, but the processing illustrated in FIG. 8 may be ended, for example, at the timing of ending the predetermined control (that is, for example, transportation of a load by the moving body 1) of the moving body 1.

In addition, in the processing illustrated in FIG. 8, it has been described that the reception power map is updated based on the detection result of the obstacle in step S7, but the detection result may be used for control (for example, selection of a route, and the like) of the moving body 1. Furthermore, the detection result of the obstacle in step S7 may be used for other processing, or may be output from the information processing apparatus 3 to an external device in order to be used for processing executed in the external device.

Hereinafter, a specific example of the operation of the information processing apparatus 3 according to the present embodiment will be described using the above-described examples illustrated in FIGS. 2 and 3.

First, the map data indicating the map illustrated in FIG. 2 is generated by moving the moving body 1 in the target space. In addition, although not illustrated, a reception power map in which reception power measured at each point on the map indicated by the map data is allocated to the point is generated. It is noted that, in the reception power map generated here, it is assumed that a dead zone in which the reception power is reduced (a space in which the propagation environment of the signal deteriorates) is not generated.

Next, a route on which the moving body 1 moves is selected based on the map data and the reception power map described above. Here, it is assumed that the route 1d illustrated in FIG. 2 is selected.

In a case where the route 1d is selected as described above, the moving body 1 is controlled to move from the start point 1b to the goal point 1c along the route 1d (so as to carry a load).

It is noted that the moving body 1 transmits map generation data and reception power data at each point on the route 1d while moving along the route 1d. In this case, the map data and the reception power map are updated based on the map generation data and the reception power data transmitted from the moving body 1.

Here, it is assumed that the obstacle 1g is disposed in the target space as illustrated in FIG. 3 while the moving body 1 is moving along the route 1d. In this case, the dead zone 1h is generated, and the reception power map is updated so that lowered reception power is allocated to a point overlapping the dead zone 1h.

According to such a reception power map, the route 1f avoiding the dead zone 1h is selected as a route on which the moving body 1 moves, and the moving body 1 is controlled to move from the start point 1b to the goal point 1c along the route 1f.

It is noted that the moving body 1 transmits the map generation data and the reception power data at each point on the route 1f while moving along the route 1f. In this case, the map data and the reception power map are updated based on the map generation data and the reception power data transmitted from the moving body 1.

Here, by comparing a first spatial frequency spectrum with a second spatial frequency spectrum calculated based on the map generation data and the reception power data transmitted at each point on the route 1f as described above, it is determined whether an obstacle exists in a space facing the antenna 2a with the moving body 1 moving along the route 1f interposed between the space and the antenna 2a.

In this case, for example, the second spatial frequency spectrum calculated based on the reception power measured when the moving body 1 passes between the obstacle 1g and the antenna 2a (that is, in front of the obstacle 1g when viewed from the antenna 2a) in a state where the obstacle 1g is not removed is significantly different from the first spatial frequency spectrum (the spectrum of the past spatial frequency calculated based on the reception power measured in a state where no obstacle exists) (that is, the first spatial frequency spectrum and the second spatial frequency spectrum are not similar). On the other hand, the second spatial frequency spectrum calculated based on the reception power measured when the moving body 1 passes between the antenna 2a and a position where the obstacle 1g existed in a state where the obstacle 1g has been removed has no significant difference from the first spatial frequency spectrum (that is, the first spatial frequency spectrum and the second spatial frequency spectrum are similar). That is, in the present embodiment, whether or not the obstacle 1g exists (is removed) can be determined by comparing the first and second spatial frequency spectra as described above.

When it is determined that no obstacle 1g exists (that is, the obstacle 1g has not been detected), the reception power map is updated so as to increase the reception power allocated to the dead zone 1h or to delete the reception power (that is, the determination result is reflected in the reception power map). According to such a reception power map, it is possible to select the route 1d again instead of the route 1f and to move the moving body 1 along the shortest route (that is, the route passing through the space 1h).

As described above, in the present embodiment, first reception power of a first signal when the first signal radiated from the antenna 2a installed in the base station 2 is received at a first point is acquired, second reception power of a second signal when the second signal that is different from the first signal and is radiated from the antenna 2a is received at a second point is acquired, and the presence or absence of an obstacle in a space facing the antenna 2a across the second point is determined based on a difference between periodicity of the first reception power and periodicity of the second reception power.

In the present embodiment, (a change in) a propagation environment of a signal in a target space according to the presence or absence of the obstacle can be efficiently grasped by detecting the obstacle (determining the presence or absence of the obstacle) based on the reception power measured at each point by the movement of the moving body 1 as described above.

It is noted that, for example, in an environment where a direct wave is dominant, it is easy to generate a propagation model, and it is considered that the presence or absence of an obstacle can be determined based on a difference between an actual measurement value such as an RSSI and a value obtained from the propagation model. However, in the case of a multipath rich environment, generation of the propagation model becomes complicated, and as such it becomes difficult to detect an obstacle using the propagation model. On the other hand, in the present embodiment, by focusing on the spatial periodicity of the reception power (the distribution of the signal power information in the space), it is possible to detect an obstacle even in a multipath environment without using a propagation model or the like.

Further, in the present embodiment, since it is assumed that the moving body 1 is controlled by a radio wave, an obstacle (for example, an empty cardboard box or the like) that allows the radio wave to be transmitted therethrough does not affect the control of the moving body 1. On the other hand, in the present embodiment, it is possible to detect a radio wave shielding object that affects the periodicity of the reception power.

Further, in the present embodiment, the first and second points (measurement target points) for measuring the reception power used to detect an obstacle include a plurality of points disposed at intervals shorter than at least ½ of a wavelength of the radio wave. In the present embodiment, with such a configuration, it is possible to improve the detection performance of an obstacle (a radio wave shielding object) in a multipath environment by acquiring reception power measured with spatially increased resolution and tracking a fluctuation in the reception power.

Further, the present embodiment uses reception power measured in a state where no obstacle (a radio wave shielding object) is disposed between the antenna 2a installed in the base station 2 and a measurement target point. That is, in the present embodiment, since an obstacle is detected using reception power measured in an area which is not affected by a radio wave shielding object and in which reception power (radio field intensity) is good (that is, an area where the reception power is high when viewed from the antenna 2a), it is not necessary to move the moving body 1 to an area where the possibility of the dead zone is high, and it is possible to avoid that the control of the moving body 1 becomes impossible.

Furthermore, in the present embodiment, a measurement target point may be determined based on a distribution of a delayed wave. According to such a configuration, by using reception power useful for detecting an obstacle (reception power that is likely to fluctuate depending on the presence or absence of an obstacle), the detection accuracy can be improved.

In addition, under the multipath environment, the influence of a multipath can be mitigated by averaging the reception power having broadband signals, but it is difficult to detect a fluctuation in a radio wave propagation path with the averaged reception power. Therefore, in the present embodiment, the detection accuracy of the fluctuation in (the radio wave propagation path affecting) the reception power is improved by using reception power of a band (that is, a narrowband) having frequency non-selective fading channel.

Furthermore, in the present embodiment, a first point and first reception power measured at the first point are stored in the storage 32 in association with each other, and when second reception power is acquired, the first reception power stored in the storage 32 is read, and an obstacle is detected by comparing the periodicity of the read first reception power with the periodicity of the acquired second reception power. In the present embodiment, with such a configuration, the presence or absence of an obstacle can be determined by comparing the periodicity of the past reception power (the first reception power of the first signal radiated from the antenna 2a in the first time zone) with the periodicity of the current reception power (the second reception power of the second signal radiated from the antenna 2a in the second time zone).

Specifically, for example, when a difference between the periodicity of the first reception power and the periodicity of the second reception power measured in a state where no obstacle exists is within a predetermined range, it can be determined that no obstacle exists. On the other hand, for example, when the difference between the periodicity of the first reception power and the periodicity of the second reception power measured in a state where no obstacle exists is out of the predetermined range, it can be determined that an obstacle exists.

In this case, it is assumed that a distance between a first point where the first reception power is measured and a second point where the second reception power is measured is less than a predetermined value. According to this configuration, by matching the points where the reception power for comparing the periodicity is measured, it is possible to improve the easiness (that is, the accuracy of determining the presence or absence of an obstacle) of grasping a fluctuation in environment.

It is noted that, in the present embodiment, the periodicity of the first reception power and the periodicity of the second reception power are represented by, for example, a spectrum of a spatial frequency, a spatial wave number, or a spatial wavelength calculated based on the spatial distributions of the first reception power and the second reception power. In the present embodiment, with such a configuration, since the periodicity of the spatial reception power can be quantified, a criterion for detecting an obstacle becomes clear, and the detection accuracy of the obstacle can be improved.

In addition, the spectrum described in the present embodiment is calculated in a range including, for example, ½ of the wavelength of the radio wave. In the present embodiment, with such a configuration, it is possible to improve the detection accuracy of an obstacle by referring to a component around the ½ wavelength in which a difference easily appears depending on the presence or absence of the obstacle.

It is noted that, in the present embodiment, it has been described that the presence or absence of an obstacle is determined using reception power measured at each point in a target space where the moving body 1 has moved. However, the reception power may be measured by, for example, a fixed sensor disposed in a dense lattice pattern (embedded in the wall surface, the floor surface, or the like) in the target space. According to such a configuration, it is not necessary to move the moving body 1 only for the purpose of measuring the reception power, and the moving body control system can be efficiently operated.

Furthermore, in the present embodiment, for example, as illustrated in FIG. 3 and the like, a case in which one obstacle is disposed in the target space has been mainly described, but a plurality of obstacles may be disposed in the target space.

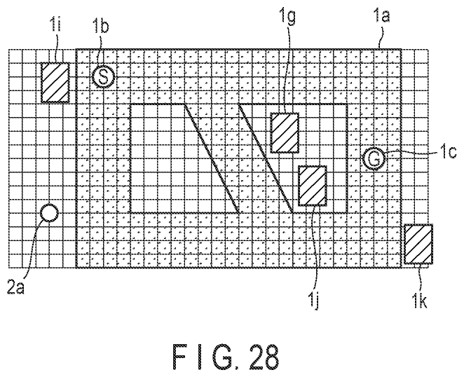

Here, for example, as illustrated in FIG. 28, it is assumed that four obstacles (loads) 1g, 1i, 1j, and 1k are disposed in the target space. In this case, for example, when the moving body 1 is moved to the vicinity of the obstacles 1g and 1j, a spatial frequency spectrum can be calculated (measured) based on reception power measured in the vicinity of the obstacles 1g and 1j. In the present embodiment, for example, when the spatial frequency spectrum (periodicity of the reception power) calculated based on the reception power measured in the vicinity of the obstacle 1g changes depending on the presence or absence of the obstacle 1g, it can be determined (estimated) that the obstacle 1g is a radio wave shielding object. On the other hand, for example, when the spatial frequency spectrum (periodicity of the reception power) calculated based on the reception power measured in the vicinity of the obstacle 1j does not change depending on the presence or absence of the obstacle 1j, it can be determined (estimated) that the obstacle 1j is not a radio wave shielding object. That is, the present embodiment may be applied to the case of estimating whether or not an obstacle disposed in a target space is a radio wave shielding object based on the periodicity of the reception power. For example, when it is determined that the obstacle 1g is a radio wave shielding object and it is determined that the obstacle 1j is not a radio wave shielding object, the processing of detecting an obstacle may be performed only for the obstacle 1g, and the processing of detecting an obstacle may not be performed for the obstacle 1j.

Furthermore, the present embodiment relates to a technique for indirectly estimating, by detecting an obstacle, a propagation environment of a signal in a space (a dead zone) where reception power has decreased. However, in the present embodiment, in an environment where a plurality of moving bodies 1 (for example, the AMRs) move in a target space, when there is a possibility that reception power decreases on the back side of an obstacle (a radio wave shielding object), the plurality of moving bodies 1 may be operated in cooperation. For example, when a first moving body 1 moves in a space where the reception power may decrease, a second moving body 1 may assist the operation of the first moving body 1 (that is, the second moving body 1 relays a control signal transmitted from the base station 2) by moving the second moving body 1 in a space that is visible from the first moving body 1. It is noted that the signal relay does not need to be performed via, for example, the moving body 1, and may be realized by installing a movable reflector in the target space.

Furthermore, in the present embodiment, for example, as described above, it has been described that the information processing apparatus 3 that performs wireless control on the moving body 1 using the local 5G, the wireless LAN, or the like detects an obstacle. However, the information processing apparatus 3 according to the present embodiment may be an apparatus prepared separately from a device that controls the moving body 1 (a wireless device such as the local 5G or the wireless LAN), and may be realized as an apparatus having only a function of detecting (that is, the determination result of the presence or absence of the obstacle is output) an obstacle using a low-cost wireless device (a transceiver configured to transmit and receive a signal in a narrow band).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

With regard to the above-described embodiments, the following supplementary notes are further disclosed.

(1)

An information processing apparatus including a processor configured to:
acquire first reception power of a first signal radiated from an antenna when the first signal is received at a first point;
acquire second reception power of a second signal radiated from the antenna, the second signal being different from the first signal, when the second signal is received at a second point; and
determine, based on a difference between periodicity of the acquired first reception power and periodicity of the acquired second reception power, presence or absence of an object in a space facing the antenna with the second point interposed between the antenna and the space.

(2)

The information processing apparatus according to (1), wherein:
the first and second signals are radiated from the antenna by a radio wave; and
the object includes a radio wave shielding object that shields the radio wave.

(3)

The information processing apparatus according to (2), wherein each of the first and second points includes a plurality of points arranged at intervals shorter than ½ of a wavelength of the radio wave.

(4)

The information processing apparatus according to (2) or (3), wherein the radio wave shielding object is not disposed between the antenna and the first and second points.

(5)

The information processing apparatus according to any one of (2) to (4), wherein the first and second points are determined based on a distribution of a delayed wave.

(6)

The information processing apparatus according to any one of (2) to (5), wherein the processor is configured to acquire the first reception power of the first signal and the second reception power of the second signal transmitted and received in a band in which there is no power fluctuation due to a frequency or the power fluctuation due to the frequency is equal to or less than a predetermined value.

(7)

The information processing apparatus according to any one of (2) to (6), further including a storage configured to store the first point and the first reception power in association with each other,
wherein the processor is configured to read, when the second reception power is acquired, the first reception power stored in the storage in association with the first point from the storage, and compare the periodicity of the read first reception power with the periodicity of the acquired second reception power to determine the presence or absence of the radio wave shielding object.

(8)

The information processing apparatus according to any one of (2) to (7), wherein the periodicity of the first reception power and the periodicity of the second reception power are represented by a spectrum of a spatial frequency, a spatial wave number, or a spatial wavelength calculated based on a spatial distribution of the first reception power and the second reception power.

(9)

The information processing apparatus according to (8), wherein the spectrum is calculated in a range including ½ of a wavelength of the radio wave.

(10)

The information processing apparatus according to any one of (2) to (9), wherein:
the first signal is radiated from the antenna in a first time zone;
the second signal is radiated from the antenna in a second time zone different from the first time zone; and
a distance between the first point at which the first signal is received and the second point at which the second signal is received is less than a predetermined value.

(11)

The information processing apparatus according to (10), wherein:
the first reception power is reception power of the first signal received in a state in which the radio wave shielding object does not exist; and
the processor is configured to determine that the radio wave shielding object does not exist when the difference between the periodicity of the first reception power and the periodicity of the second reception power is within a predetermined range, and determine that the radio wave shielding object exists when the difference between the periodicity of the first reception power and the periodicity of the second reception power is out of the predetermined range.

(12)

A system including:
the information processing apparatus according to any one of (1) to (11); and
a moving body communicably connected to the information processing apparatus,
wherein the moving body receives the first signal at the first point, measures the first reception power of the received first signal, receives the second signal at the second point, and measures the second reception power of the received second signal.

(13)

A method including:
acquiring first reception power of a first signal radiated from an antenna when the first signal is received at a first point;
acquiring second reception power of a second signal radiated from the antenna, the second signal being different from the first signal, when the second signal is received at a second point; and
determining, based on a difference between periodicity of the acquired first reception power and periodicity of the acquired second reception power, presence or absence of an object in a space facing the antenna with the second point interposed between the antenna and the space.

(14)

A non-transitory computer-readable storage medium having stored thereon a program which is executed by a computer, the program including instructions capable of causing the computer to execute functions of:
acquiring first reception power of a first signal radiated from an antenna when the first signal is received at a first point;
acquiring second reception power of a second signal radiated from the antenna, the second signal being different from the first signal, when the second signal is received at a second point; and
determining, based on a difference between periodicity of the acquired first reception power and periodicity of the acquired second reception power, presence or absence of an object in a space facing the antenna with the second point interposed between the antenna and the space.

What is claimed is:

1. An information processing apparatus comprising a processor configured to:
acquire first reception power of a first signal radiated from an antenna when the first signal is received at a first point;
acquire second reception power of a second signal radiated from the antenna, the second signal being different from the first signal, when the second signal is received at a second point; and
determine, based on a difference between periodicity of the acquired first reception power and periodicity of the acquired second reception power, presence or absence of an object in a space facing the antenna with the second point interposed between the antenna and the space.

2. The information processing apparatus according to claim 1, wherein:
the first and second signals are radiated from the antenna by a radio wave; and
the object includes a radio wave shielding object that shields the radio wave.

3. The information processing apparatus according to claim 2, wherein each of the first and second points includes a plurality of points arranged at intervals shorter than ½ of a wavelength of the radio wave.

4. The information processing apparatus according to claim 2, wherein the radio wave shielding object is not disposed between the antenna and the first and second points.

5. The information processing apparatus according to claim 2, wherein the first and second points are determined based on a distribution of a delayed wave.

6. The information processing apparatus according to claim 2, wherein the processor is configured to acquire the first reception power of the first signal and the second reception power of the second signal transmitted and received in a band in which there is no power fluctuation due to a frequency or the power fluctuation due to the frequency is equal to or less than a predetermined value.

7. The information processing apparatus according to claim 2, further comprising a storage configured to store the first point and the first reception power in association with each other,
wherein the processor is configured to read, when the second reception power is acquired, the first reception power stored in the storage in association with the first point from the storage, and compare the periodicity of the read first reception power with the periodicity of the acquired second reception power to determine the presence or absence of the radio wave shielding object.

8. The information processing apparatus according to claim 2, wherein the periodicity of the first reception power and the periodicity of the second reception power are represented by a spectrum of a spatial frequency, a spatial wave number, or a spatial wavelength calculated based on a spatial distribution of the first reception power and the second reception power.

9. The information processing apparatus according to claim 8, wherein the spectrum is calculated in a range including ½ of a wavelength of the radio wave.

10. The information processing apparatus according to claim 2, wherein:
the first signal is radiated from the antenna in a first time zone;
the second signal is radiated from the antenna in a second time zone different from the first time zone; and
a distance between the first point at which the first signal is received and the second point at which the second signal is received is less than a predetermined value.

11. The information processing apparatus according to claim 10, wherein:
the first reception power is reception power of the first signal received in a state in which the radio wave shielding object does not exist; and
the processor is configured to determine that the radio wave shielding object does not exist when the difference between the periodicity of the first reception power and the periodicity of the second reception power is within a predetermined range, and determine that the radio wave shielding object exists when the difference between the periodicity of the first reception power and the periodicity of the second reception power is out of the predetermined range.

12. A system comprising:
the information processing apparatus according to claim 1; and
a moving body communicably connected to the information processing apparatus,
wherein the moving body is configured to receive the first signal at the first point, measure the first reception power of the received first signal, receive the second signal at the second point, and measure the second reception power of the received second signal.

13. A method comprising:
acquiring first reception power of a first signal radiated from an antenna when the first signal is received at a first point;
acquiring second reception power of a second signal radiated from the antenna, the second signal being different from the first signal, when the second signal is received at a second point; and
determining, based on a difference between periodicity of the acquired first reception power and periodicity of the acquired second reception power, presence or absence of an object in a space facing the antenna with the second point interposed between the antenna and the space.

14. A non-transitory computer-readable storage medium having stored thereon a program which is executed by a computer, the program comprising instructions capable of causing the computer to execute functions of:
acquiring first reception power of a first signal radiated from an antenna when the first signal is received at a first point;
acquiring second reception power of a second signal radiated from the antenna, the second signal being different from the first signal, when the second signal is received at a second point; and
determining, based on a difference between periodicity of the acquired first reception power and periodicity of the acquired second reception power, presence or absence of an object in a space facing the antenna with the second point interposed between the antenna and the space.
